(19) United States
(12) Patent Application Publication
(10) Pub. No.: US 2004/0062525 A1
(43) Pub. Date: Apr. 1, 2004

(54) Video processing system

(75) Inventors: Makoto Hasegawa, Fukuoka (JP); Yuji Nagano, Fukuoka (JP); Kenji Orita, Fukuoka (JP); Hirofumi Kamimaru, Fukuoka (JP); Hideaki Ishii, Fukuoka (JP); Chikara Imajou, Fukuoka (JP); Shinichirou Miyajima, Fukuoka (JP); Yuji Ishii, Fukuoka (JP); Jun Endoh, Fukuoka (JP); Miwa Shigematsu, Fukuoka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/663,676

(22) Filed: Sep. 17, 2003

(30) Foreign Application Priority Data
Sep. 17, 2002 (JP) 2002-269795

(51) Int. Cl. H04N 5/76; H04N 5/225

(52) U.S. Cl. 386/69; 386/117

(57) ABSTRACT

A video processing system which realizes high efficiency and improved service quality in video production, including high-speed extraction of scenes related to a particular subject and compilation of a personalized video product. Video recording units are placed along a given course, each of which stores video of moving objects that is captured by a fixed camera, together with time stamps that indicate at what time each part of the video was taken. At checkpoints on the course, time measurement units measure checkpoint passage time of every passing moving object and store checkpoint time records including the measured checkpoint passage times and identifiers of individual moving objects. A video authoring unit searches the stored video data to find and extract scenes of a particular moving object, using the checkpoint time records in association with time stamps in the video data, and compiles the extracted scenes into a personalized video product.

### BACKGROUND OF THE INVENTION

1. Field of the Invention

The present invention relates to a video processing system, and more particularly to a video processing system that shoots video of moving objects at a plurality of points, extracts intended scenes, and compiles them into a video product.

2. Description of the Related Art

With the recent advancement of multimedia video technologies, particularly that of the data compression techniques for digital motion pictures, a number of video information services have become available in various fields, raising increased expectations for more sophisticated and higher quality ones. Such advanced services include those in the area of sports. For example, high-definition television (HDTV) live programs permit us to enjoy sports game watching, during which some additional data can be delivered in real time by using a surplus bandwidth that has been produced as a result of video signal compression. Service needs lie not only on the side of spectators. Athletes participating in a sports event also wish to have their video records as a data source for improving their abilities, or as a souvenir of their participation.

To meet the increasing needs, some operating organizations have introduced a facility for shooting videos and offer the records to participants of sports events. Consider a marathon or triathlon race, for example. During the race, runners change their locations with the passage of time, being tracked by a plurality of cars each carrying a video camera. The car-mounted cameras take moving pictures of runners, and the video record of the entire race is made available for sale after the event is finished.

Another proposed application of video media in the field of sports is golf swing analyzers. They shoot video of a player and measure the velocity, angle, and direction of his/her swing motion. For an example of this type of technologies, see the Unexamined Japanese Patent Application Publication No. 8-242467 (1996), paragraphs 0009 to 0012 and FIG. 1.

The aforementioned video recording system for marathon or triathlon races uses a plurality of camera-equipped vehicles and requires many specialists to shoot video of runners who move as time passes. If the number of cameras is limited, it becomes difficult to provide a sufficient number of shooting points. Further, in a marathon or triathlon race, the line of race participants (from top runner to last runner) increases its length as time passes, meaning that the camera coverage has to be expanded accordingly. This nature of the races makes it very difficult for the conventional system to track all runners throughout the course.

In addition to the above, there are such services that extract video scenes of a particular person and write them in an appropriate video storage medium to provide a personalized video product. Conventional methods require a human editor to scan the entire video data to find and extract relevant scenes by checking the race number of each runner seen in the video. The cost of this labor-intensive, time-consuming task pushes up the product price, and besides, race participants have to wait for a long time before they can receive their video records. For well-motivated athletes who are eager to improve their own racing techniques, the lack of timeliness reduces the value of those services.

### SUMMARY OF THE INVENTION

In view of the foregoing, it is an object of the present invention to provide a video processing system which realizes high efficiency and improved service quality in video production, including high-speed extraction of scenes related to a particular subject and compilation of a personalized video product.

To accomplish the above object, according to the present invention, there is provided a video processing system that shoots video of moving objects at a plurality of points, extracts intended scenes, and compiles the extracted scenes into a video product. This system comprises (a) a plurality of video recording units, (b) a plurality of time measurement units, and (c) a video authoring unit. Each video recording device has a fixed camera that captures video of each passing moving object, and a video storage controller that stores video data including the captured video of the moving objects and time stamps that indicate at what time each part of the video was captured. The time measurement units are deployed at checkpoints, each of which measures checkpoint passage time of each passing moving object and stores checkpoint time records including the measured checkpoint passage times and identifiers of individual moving objects. The video authoring unit searches the video data stored in the video recording units to find and extract scenes of one of the moving objects, using the checkpoint time records in association with time stamps in the video data, and compiles the extracted scenes into a video product.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a conceptual view of a video processing system according to the present invention.

FIGS. 2 and 3 show a total block diagram of the proposed video processing system.

FIGS. 4 and 5 show video shooting period at each checkpoint along the course.

FIG. 6 is a flowchart which gives an outline of how the present invention works.

FIG. 7 shows how a fixed point camera is set up.

FIG. 8 shows the camera setup of FIG. 7 viewed from point A.

FIG. 9 shows the structure of a video recording unit.

FIG. 10 shows the amount of data stored in a hard disk drive.

FIG. 11 illustrates a situation where a camera is shooting video of runners and the system records their checkpoint passage times.

FIGS. 12 and 13 show the association between checkpoint time records and time stamps.

FIG. 14 shows the hierarchical structure of video data.

FIG. 15 shows a race number/chip ID mapping table.

FIGS. 16 to 19 show checkpoint time record tables for several different points.

FIGS. 20 and 21 show the relationship between data items of an index file and MPEG2 video data.

FIG. 22 shows a mapping table that associates shooting section numbers and their corresponding time offsets.

FIGS. 23 to 26 shows several examples of camera arrangement and their corresponding video condition data.

FIG. 27 shows an example of video configuration file format.

FIG. 28 shows an example of a personalized video authoring process using a video configuration file.

FIG. 29 shows an example situation where two fixed cameras cover the areas before and after a checkpoint.

FIG. 30 shows an example situation where two fixed cameras cover the areas before a checkpoint.

FIG. 31 shows an example of video condition data.

FIG. 32 shows another way to shoot video of runners and record their checkpoint passage times.

FIGS. 33 and 34 show how race numbers are inserted in a video data stream.

FIGS. 35 and 36 show the arrangement of video shooting periods to expedite the delivery of personalized video products.

### DESCRIPTION OF THE PREFERRED EMBODIMENTS

Preferred embodiments of the present invention will be described below with reference to the accompanying drawings, wherein like reference numerals refer to like elements throughout.

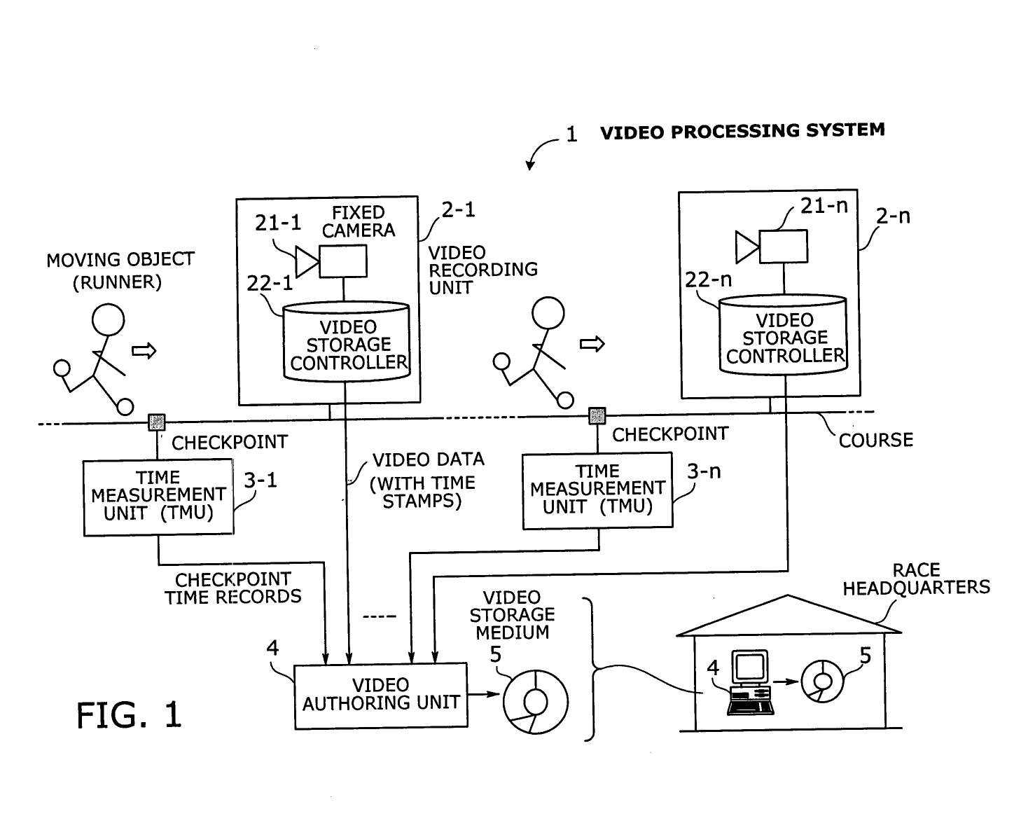

FIG. 1 is a conceptual view of a video processing system according to the present invention. This video processing system 1 is made up of a plurality of video recording units 2-1 to 2-n, a plurality of time measurement units 3-1 to 3-n, and a video authoring unit 4. Each video recording unit 2-1 to 2-n has a fixed camera 21-1 to 21-n and a video storage controller 22-1 to 22-n. The video storage controllers 22-1 to 22-n store the video of moving objects that are captured by the fixed cameras 21-1 to 21-n, respectively, together with time stamps indicating at what time each part of the video was captured. The time measurement units 3-1 to 3-n are placed at appropriate intervals along a given course to measure the time when each moving object passes there. Those time measurement points are referred to herein as “checkpoints.” The time measurement units 3-1 to 3-n store checkpoint time records that include the identifier of each moving object (e.g., race numbers in the case the objects are runners) and the measured checkpoint passage time. The video authoring unit 4 automatically searches the video data stored in the video recording units 2-1 to 2-n, referring to the checkpoint time records in association with the time stamps of the video data and identifying scenes of each particular moving object at each checkpoint. It extracts those scenes and compiles them into a video data stream. The video authoring unit 4 further writes the compiled video data stream in a video storage medium 5.

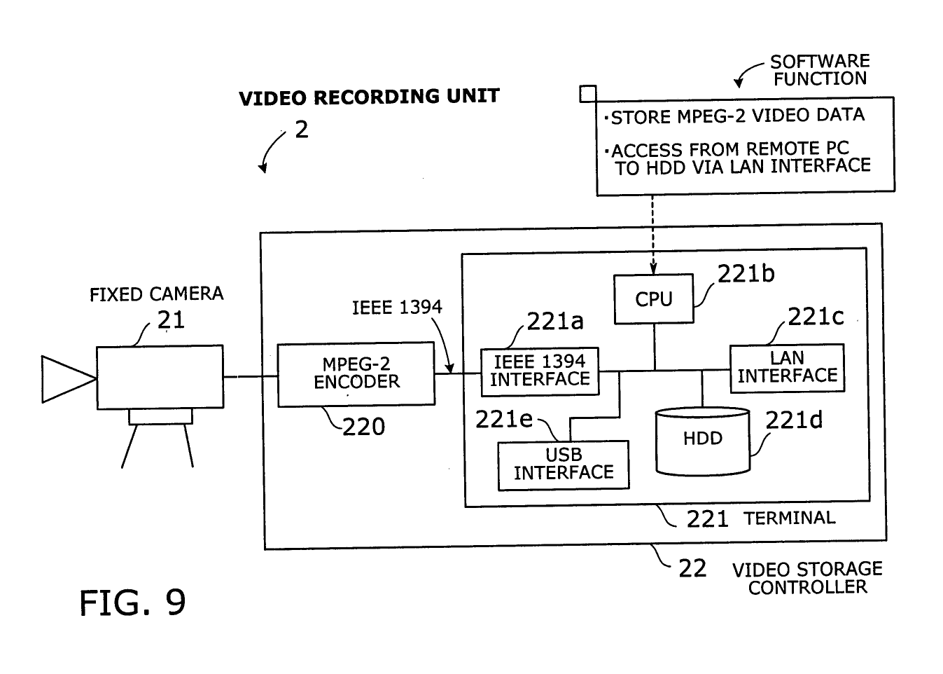

Here it is assumed, for example, that the moving objects are athletes such as runners in a distance race. In this case, the video recording units 2-1 to 2-n are located at a plurality of points on the race course to shoot video of runners moving along it. The time measurement units 3-1 to 3-n are also placed at checkpoint along the course. Those video recording units and time measurement units output video records and checkpoint time records of all runners throughout the race course. The data collected in this way is then supplied to the video authoring unit 4, which is located at, for example, the race headquarters. The video authoring unit 4 searches the collected video data to extract scenes of each particular runner. (When it is possible and appropriate, this task of video data retrieval may be executed by the video storage controllers 22-1 to 22-n, as will be described later in FIG. 9.) The video authoring unit 4 also extracts some common scenes before and after the race as the prologue and epilogue and then compiles those extracted scenes into a personalized video for each individual runner who wishes it. Finally the video authoring unit 4 writes each set of personalized video files into a video storage medium 5 such as CD-ROMs.

The system has to measure the time when a moving object passes by a specific place. In the present case, each runner's checkpoint passage time should be recorded. Actually there are many techniques for collecting such time records, and an appropriate one of those existing techniques can be chosen to implement the above-described time measurement units 3-1 to 3-n. For example, the time measurement units 3-1 to 3-n may use a recording system made up of a small tracer chip and a timer device having data storage functions. In this system, every runner wears a tracer chip on his/her wrist or ankle to send and receive radio wave signals. The timer device is placed on the surface of the race course road so that it will be able to communicate with the tracer chips. Each time a runner passes the check point, the timer unit records the time. (For related techniques, refer to, for example, the published unexamined Japanese patent applications No. 2000-271259 and No. 2002-204119.) Tracer chips have unique chip identifiers (IDs). When handing over a tracer chip to each runner before the race starts, race officials record the chip ID and race number for later use, so that they will be able to refer to these two pieces of information in an associated way.

As we have already mentioned, typical applications of the proposed video processing system 1 include marathon and triathlon races, in which the location of each runner changes with time. Assuming this type of application, the next section will now describe the operation of the system 1 in greater detail.

The present invention has been motivated by the following needs of race participants: (a) they wish to have a video record that contains many shots and scenes involving themselves; and (b) they wish to get a video record of the race before their memory fades away, or before the next race comes. To serve those needs, the present invention provides a system to extract scenes involving each individual runner out of the entire collection of videos that have been recorded at a plurality of points on the course, combines all those scenes into personalized videos, and passes them to the participants on the very day of the race. For example, the desired performance of this system is such that it can output a personalized video data stream at least every five minutes and deliver complete video products to one hundred race participants in the very day the race took place.

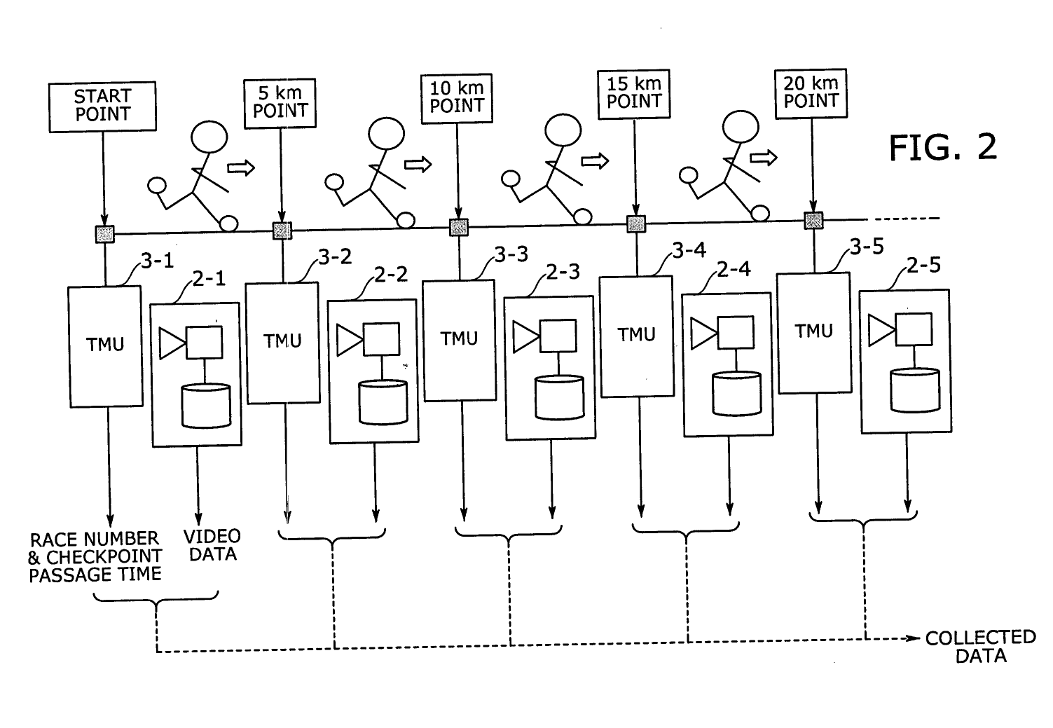

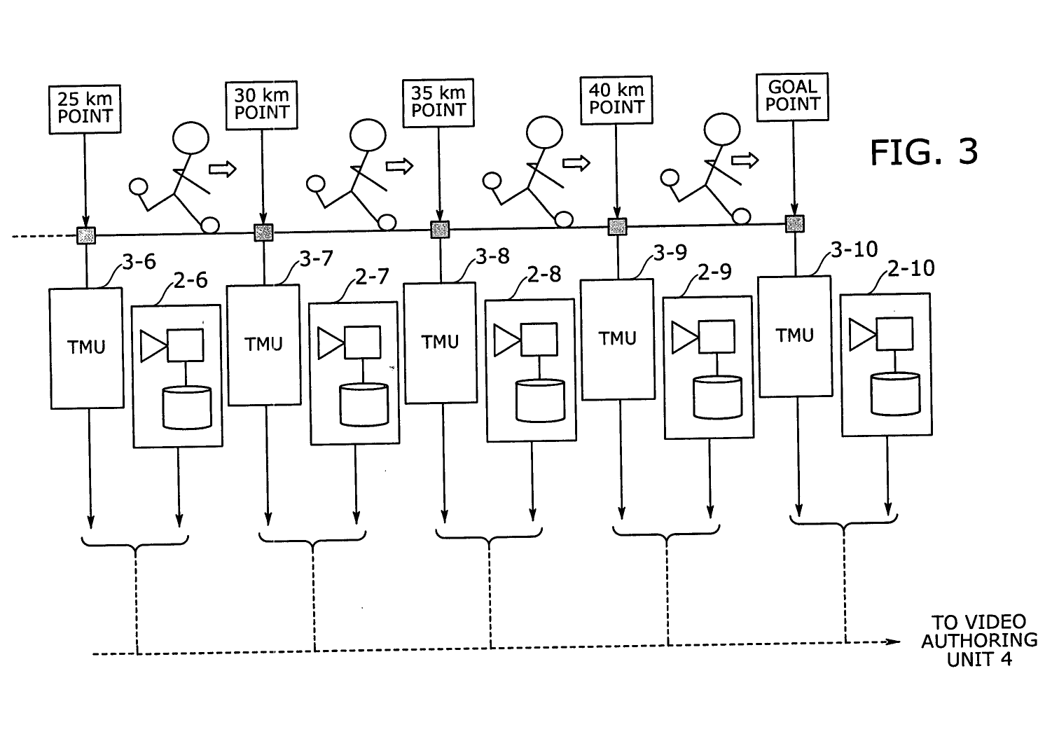

FIGS. 2 and 3 show a total block diagram of the proposed video processing system 1, which is used in a 42.195-km full marathon race. Video recording units 2-1 to 2-n and time measurement units 3-1 to 3-n are deployed on the course at appropriate intervals. The time measurement units 3-1 to 3-n distinguishes each passing runner from the others and measures and records their respective checkpoint passage times. There is no upper limit on the number of video recording units or time measurement units because they operate independently at different timings from checkpoint to checkpoint. One fixed camera typically covers a range of about 100 m. Under the assumption that cameras are placed at 100-m intervals, it is required to deploy 422 units for complete coverage of a full marathon course of 42.195 km.

The video storage controller 22-1 to 22-n in each video recording unit 2-1 to 2-n stores the video data containing moving images of all runners, who are supposed to pass every checkpoint along the race course. In the full-marathon applications, they have to be capable of recording videos for at most six hours continuously. FIGS. 2 and 3 give an example system that is simplified for easy understanding. This system covers the entire marathon course of 42.195 km by using ten time measurement units 3-1 to 3-10, together with video recording units 2-1 to 2-10 placed nearby. They are located at every 5 km, except the last section (between 40 km point and goal point) that is only 195 meters in length. FIGS. 2 and 3 further show that the captured data is directed to the video authoring unit 4. The following description will assume such a simplified system configuration.

The time measurement units 3-1 to 3-10 collect checkpoint time records, including the passing runners' identifiers (e.g., race numbers) and checkpoint passage times, while the video recording units 2-1 to 2-10 collect video data. Following the passage of all runners, the video recording units and time measurement units are removed one by one, since they have accomplished their duty. Those pieces of equipment, together with the collected time records and video data, are then carried by car to the race headquarters.

The system has a video authoring unit 4 at an appropriate location (e.g., at the race headquarters as in the present example) to centrally manage all video data and time records collected from the checkpoints. The video authoring unit 4 comprises a hard disk unit to store a large amount of digital video data, a personal computer to edit video files, and a medium writer to write the edited video files into storage media for delivery and sales of personalized video products.

Because the users of this service may have different kinds of video players, the video authoring unit 4 has to support a plurality of video storage media types. In the case of, for example, analog video tape format, the video authoring unit 4 needs the functions of (a) decoding realtime a given MPEG-2 file of personalized video data, (b) converting it to NTSC format, and (c) recording the video using a videocassette recorder (VCR).

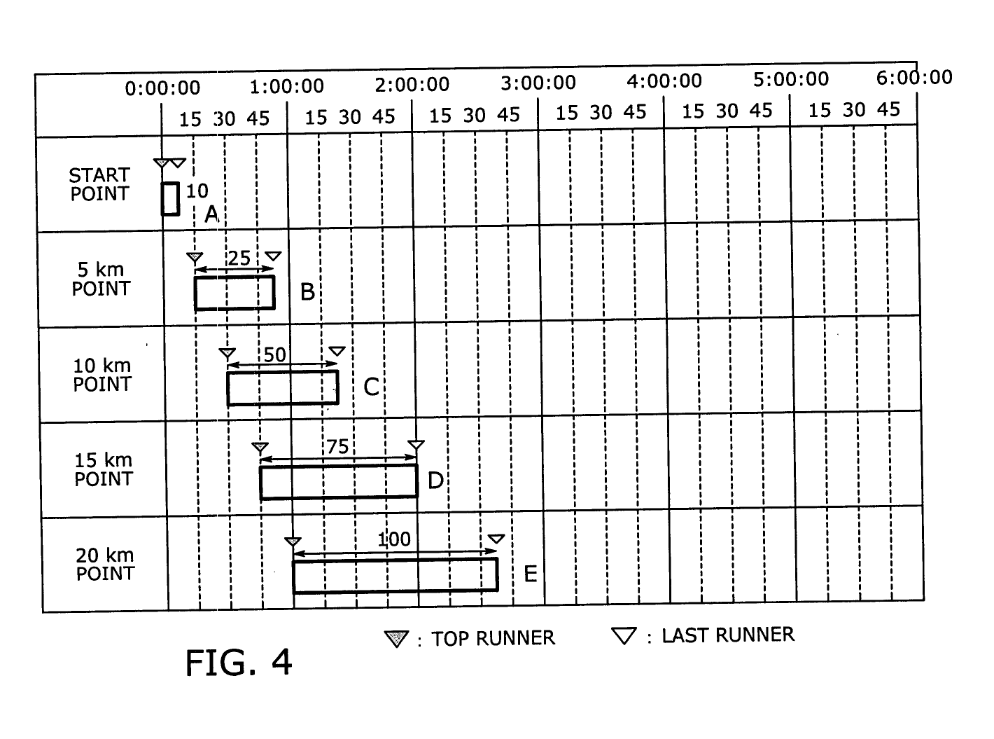

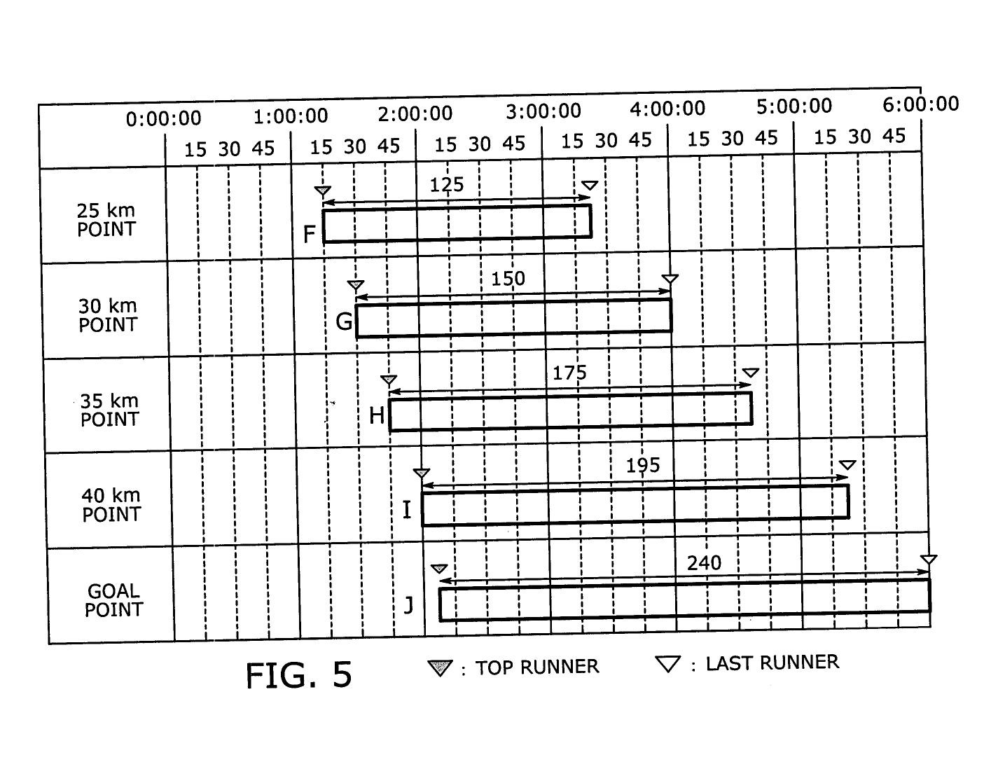

FIGS. 4 and 5 show the video shooting periods during which the video recording units 2-1 to 2-10 placed along the marathon course of FIGS. 2 and 3 are to operate. At the start point, it takes ten minutes for all runners, from the top to the last, to leave the camera range. Accordingly, the first video recording unit 2-1 begins shooting at the start time and operates for ten minutes until the last runner passes. The resulting video is referred to as video data A. At 5 km point, it takes 25 minutes for all runners to pass the camera range. Accordingly, the second video recording unit 2-2 begins shooting when the top runner comes and operates for 25 minutes until the last runner passes. The resulting video is referred to as video data B.

The motion pictures of runners are taken at each checkpoint in the above-described way. Because runners tend to distribute wider and wider along the course as they near the goal, the time span from the top runner to the last runner reaches 240 minutes (four hours) in the present example. The last video recording unit 2-10 at the goal point therefore begins shooting when the top runner comes and operates for 240 minutes until the last runner passes. The resulting video is referred to as video data J.

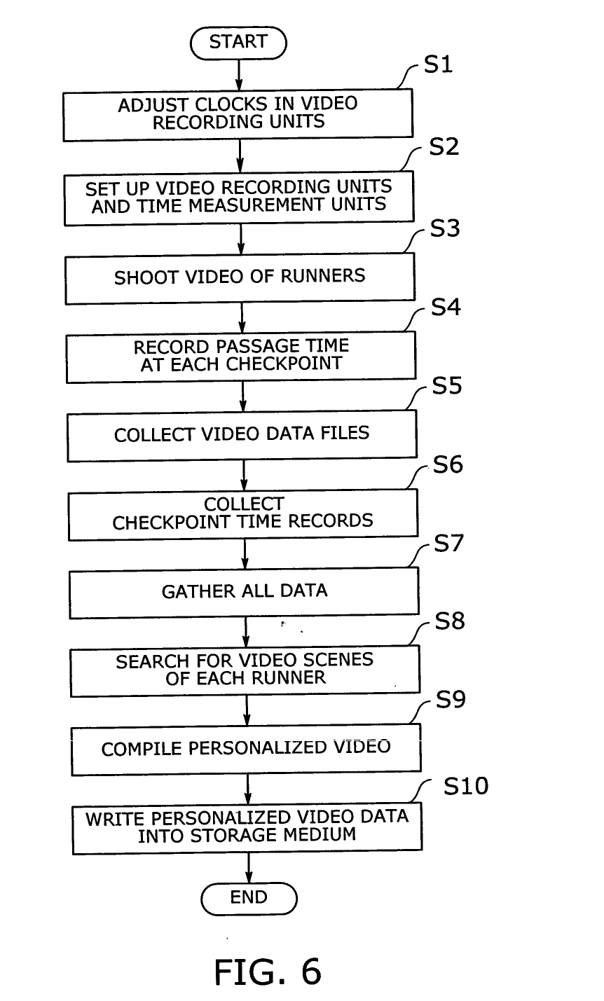

Referring now to the flowchart of FIG. 6, the following will explain the outline of how the video processing system 1 works, from setup of video recording units 2-1 to 2-10 and time measurement units 3-1 to 3-10 on the race course to production of video storage medium 5. The process proceeds according to the following steps:

(S1) The internal clocks of all video recording units 2-1 to 2-10 are adjusted. Specifically, they are adjusted in accordance with a standard time base that provides the timing of various operations, including when to start and stop video shooting and what time stamp to append to each video data stream.

(S2) Video recording units 2-1 to 2-10 are placed at predetermined shooting points along the course, which involves adjustment of viewing angles and ranges of fixed cameras 21-1 to 21-10. Also time measurement units 3-1 to 3-10 are set at the checkpoints.

(S3) At each shooting point, the fixed camera 21-1 to 21-10 shoots video of all passing runners, from the top to the last. The actual shooting start times and end times vary from point to point to minimize the amount of video data.

To supervise the course safety, race staff are dispatched to the checkpoints and other locations along the course. Control of the video recording units 2-1 to 2-10, including start and stop, will be one of their duties.

(S4) The time measurement unit 3-1 to 3-n at each checkpoint measures checkpoint passage time of every passing runner.

(S5) Some race staff collect video data files from the video recording units 2-1 to 2-10 in the order that they finish recording. As has been mentioned earlier, one possible method for this is to dispatch a car to pick up the equipment and data files altogether. Alternatively, a wired or wireless network (e.g., phone lines or LAN facilities) may be used to transfer remote files to the race headquarters.

(S6) Along with picking up video data files, the race staff collect checkpoint time records from the time measurement units 3-1 to 3-10 in the order that they finished time measurement for all runners, using a similar method as described in step S5.

(S7) All the collected data are brought together in the race headquarters.

(S8) To create a personalized video product for a specified runner, the video authoring unit 4 searches the entire video file of each checkpoint to find a scene in which the runner is seen. It references a video configuration file in this search process. We will discuss this in a later section.

(S9) The video authoring unit 4 extracts scenes of the specified runner from each video file. In this way, personal video scenes are extracted for all individual runners and for all checkpoints. Also created are some common video clips such as a title screen, race prologue, and race epilogue. When all those source video scenes and clips are ready, the video authoring unit 4 then compiles them into one combined set of personalized video data for each individual runner.

(S10) The video authoring unit 4 writes each set of personalized video data in an appropriate video storage medium 5.

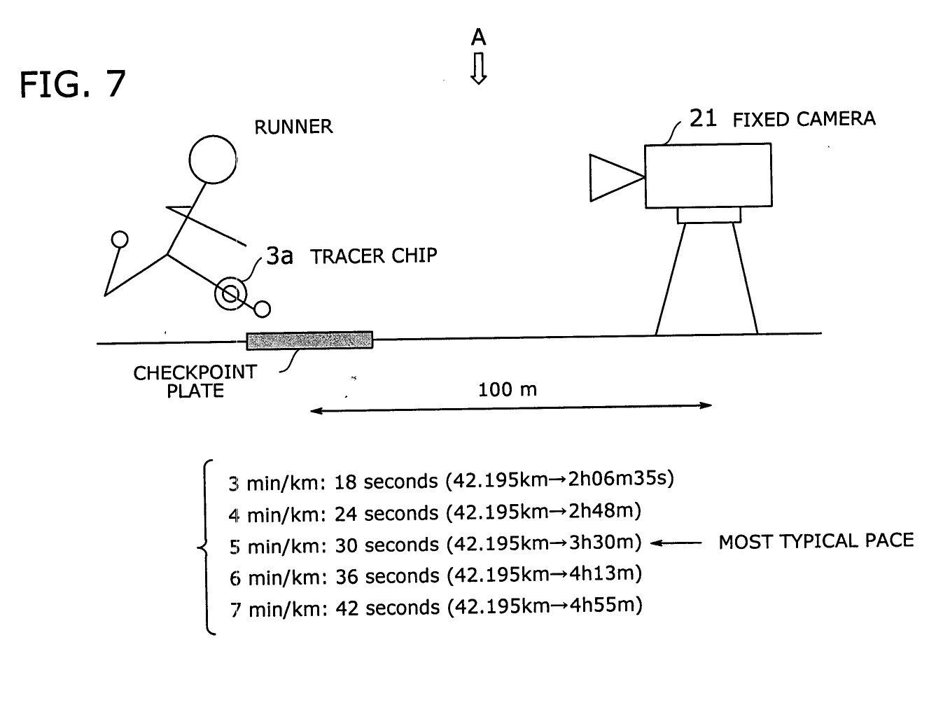

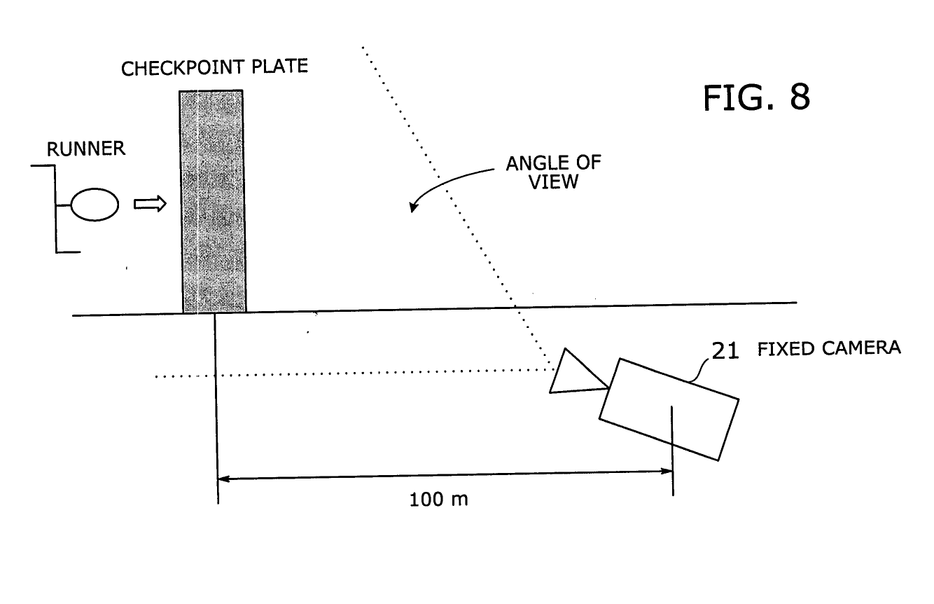

FIG. 7 shows how a fixed point camera is set up, and FIG. 8 shows the camera setup of FIG. 7 viewed from point A above the ground. These diagrams illustrate a situation where a runner wearing a tracer chip 3a is passing over a checkpoint plate and a fixed camera 21 placed 100 m away from that point is taking his/her video pictures. For example, if he/she is capable of running 1 km in three minutes, it will take eighteen seconds for 100 m. This is equivalent to 2 hours 6 minutes 30 seconds for the full marathon distance of 42.195 km, which is comparable to the pace of world records. Another example is five minutes for 1 km, in which case the runner needs thirty seconds for 100 m, and 3 hours 30 minutes for 42.195 km. Records of this kind are most frequently seen in marathon races, i.e., the typical pace of most runners.

Suppose here that the fixed camera 21 in the example of FIGS. 7 and 8 runs for 30 seconds, covering a section of 100 m. In this situation, even the fastest runner would appear in the video for at least 18 seconds during the 30-second shooting period. If the system could supply a runner with his/her own personalized video file containing at least 18-second scene at every checkpoint with a distance of 5 km, the runner would find the video useful and well worth buying.

FIG. 9 shows the structure of video recording units 2. Video recording units 2 are located at different points to obtain a continuous long-time video record, each of which is formed from a fixed camera 21 and a video storage controller 22. The video storage controller 22 has, among others, an MPEG-2 encoder 220 and a terminal (personal computer) 221.

The terminal 221 is composed of, among others, an IEEE 1394 interface 221a, a central processing unit (CPU) 221b, a LAN interface 221c, a hard disk drive (HDD) 221d, and a USB interface 221e. The MPEG-2 encoder 220 performs realtime encoding of video signals sent from the fixed camera 21. This MPEG-2 encoder 220 is connected to the terminal 221 through an IEEE 1394 link. The terminal 221 uses its IEEE 1394 interface 221a to receive video data that is encoded in the MPEG-2 format. The CPU 221b stores the received MPEG-2 vided data in the HDD 221d. It also controls access to the HDD 221d, including video data retrieval, when requested from other personal computers through the LAN interface 221c. The USB interface 221e provides serial link connections for peripheral devices such as mouse devices, keyboards, and modems.

Besides storing captured video data, the video storage controller 22 may also serve as a video processor that works in cooperation with the video authoring unit 4 when searching video data for desired scenes. The video storage controller 22 retrieves motion pictures from video data using shooting time data and checkpoint passage data. Here, the video data contains motion pictures captured by the fixed camera 21 that is placed at a predetermined distance from a checkpoint. Shooting time data (also referred to as time stamps) indicates at what time each part of video data was captured. Checkpoint passage data (also referred to as checkpoint time records) gives a time record that indicates at what time a moving object (e.g., runner) passed the checkpoint, in association with the identifier of that object.

To achieve the above, the CPU 221b acts as a time record retrieval unit and a video record retrieval unit. That is, the CPU 221b first searches the checkpoint passage data for a time record that corresponds to the identifier of a particular runner, and it then identifies shooting time data having a predetermined temporal relationship with the time record that is found. After that it retrieves motion pictures corresponding to the identified shooting time data from the video data stored in the HDD 221d.

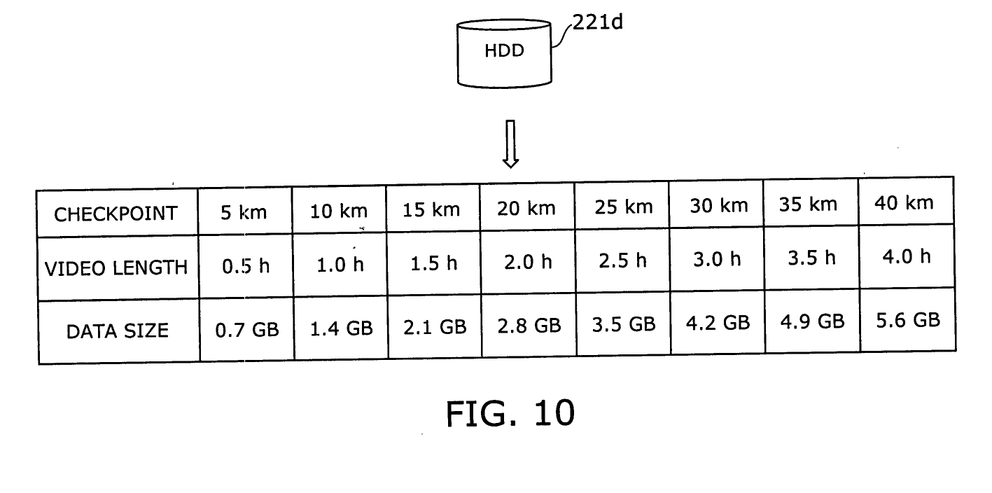

FIG. 10 explains the amount of data stored in the HDD 221d. Specifically, the table of FIG. 10 shows the video length and the amount of video data at each checkpoint on the course, assuming that video data is encoded into MPEG-2 files with a bitrate of 3 Mbps. See the column of 5 km checkpoint, for example. The table shows that the video data files at this checkpoint amount to 0.7 gigabytes (GB) for the length of 0.5 hours. The column of 40 km checkpoint, on the other hand, shows that the video data files amount to 5.6 GB for the length of 4.0 hours. Although the amount of video data is not small, it is not a problem at all for the video storage controller 22 because large capacity hard disk drives are available in the market today.

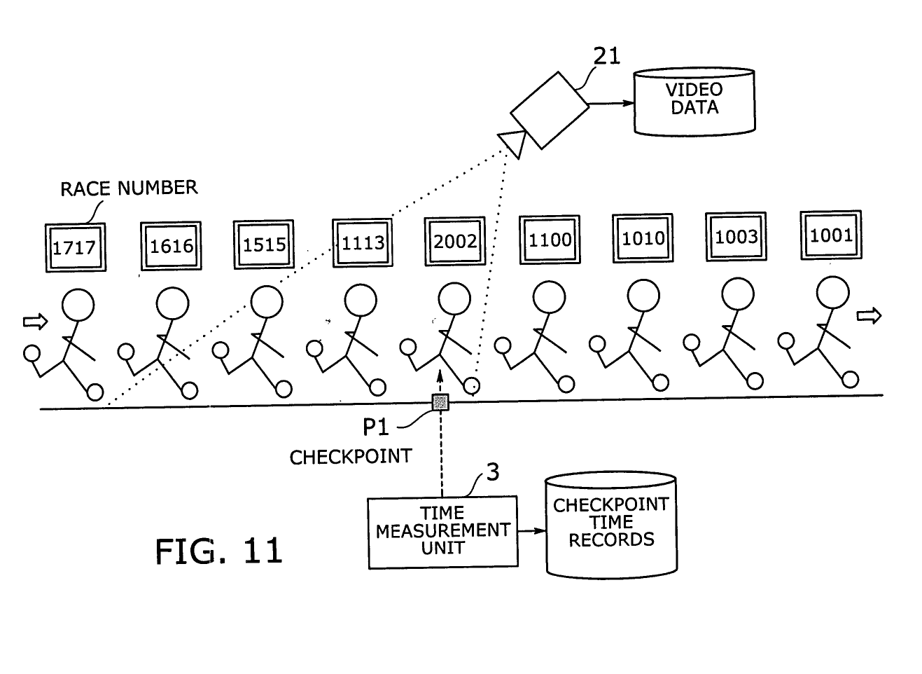

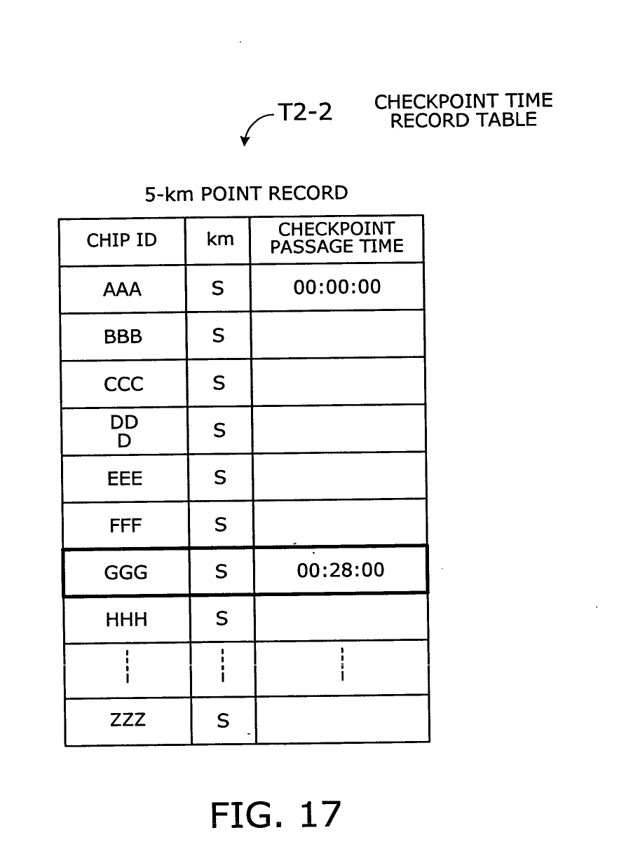

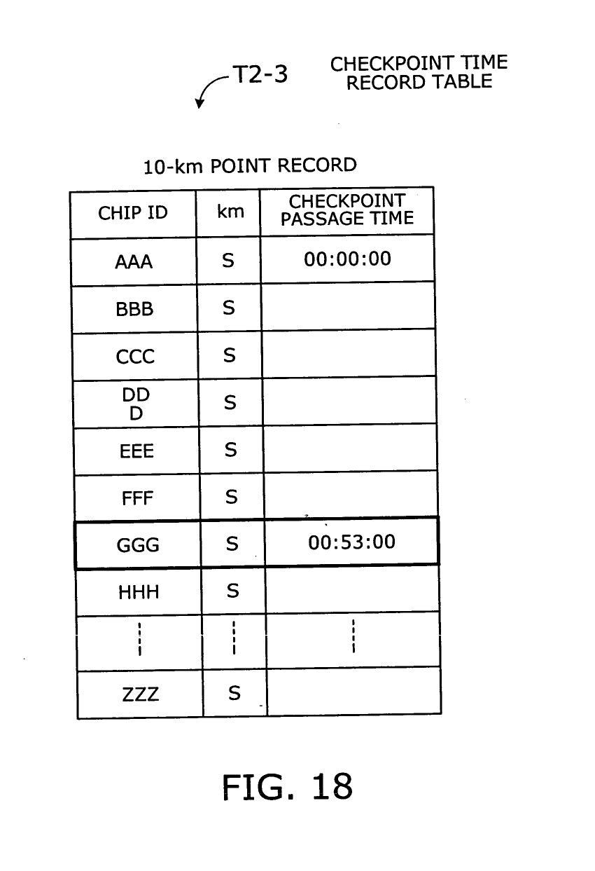

Referring next to FIGS. 11 to 21, we will now describe how to retrieve personal scenes from video data. FIG. 11 illustrates a situation where a camera is shooting video of runners and the system is recording their checkpoint passage times. A time measurement unit 3 is installed at checkpoint P1, and a fixed camera 21 is placed nearby, so that it can catch the view of approaching runners. FIG. 11 illustrates nine runners on the course, including the runner with race number “2002” who is just going past the checkpoint P1.

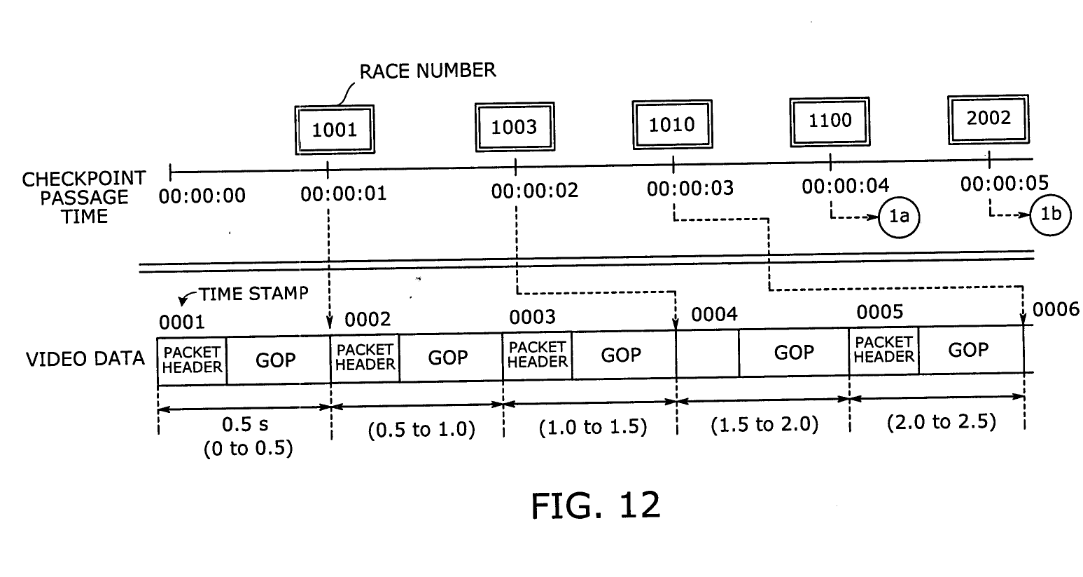

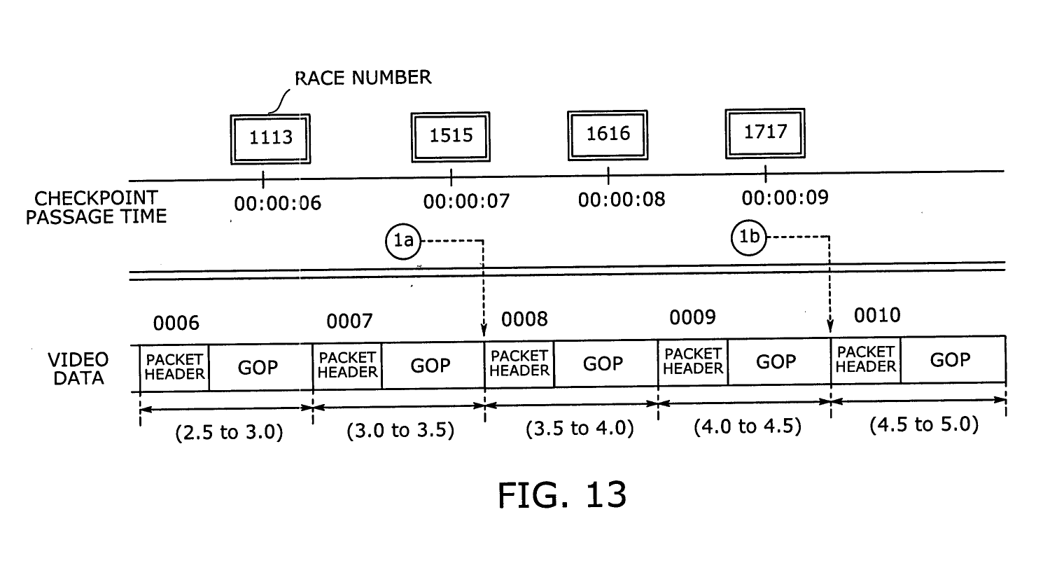

FIGS. 12 and 13 show the association between checkpoint time records and time stamps. More specifically, it shows the race number of each passing runner, checkpoint passage times, and video data obtained at checkpoint P1. For example, a runner “1001” has passed checkpoint P1 at 00:00:01, and another runner “2002” at 00:00:05. Video data is represented as a series of packets, each of which is 0.5 seconds in length and composed of a packet header and a Group of Picture (GOP) field.

The video data captured at checkpoint P1 from the initial time point 00:00:00 is associated with the checkpoint passage time of each passing runner as follows. Take the runner wearing race number 2002 as an example. As mentioned above, he/she has passed checkpoint P1 at 00:00:05. Since one packet contains a video stream of 0.5 seconds, the scene including the runner passing checkpoint P1 is likely to be found in the tenth packet. More precisely, the tenth packet records a scene that starts 0.5 seconds before checkpoint P1 and ends at the time when he/she reaches P1. Because this packet has a time stamp of “0010” corresponding to the checkpoint passage time “00:00:05,” we can obtain a personal scene of the runner “2002” approaching checkpoint P1 by extracting the packet with time stamp “0010” and earlier ones.

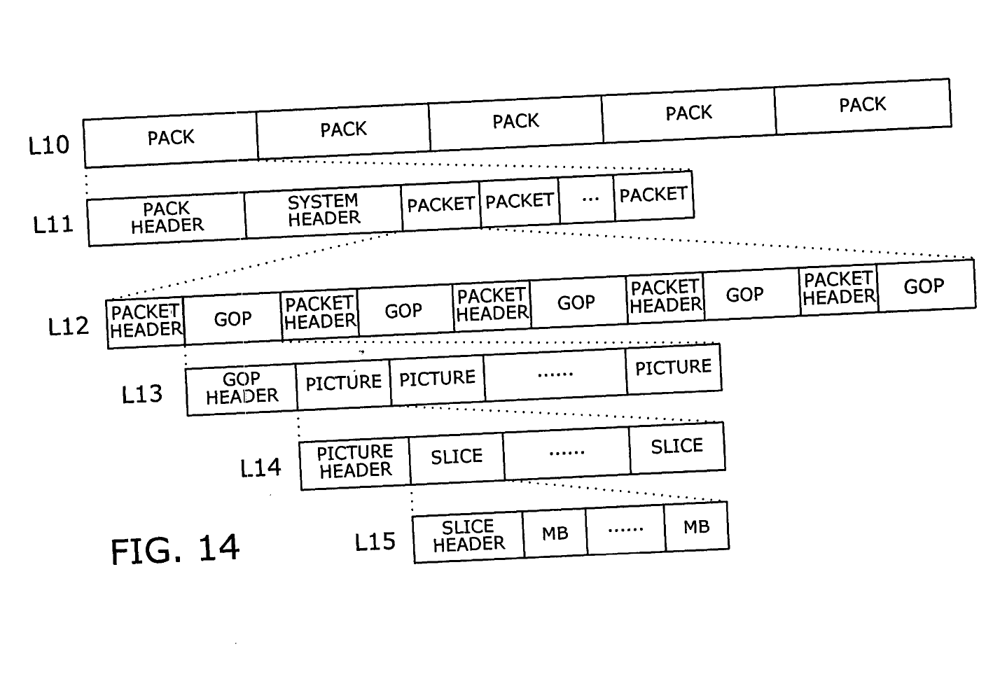

FIG. 14 shows the hierarchical structure of video data. The top layer L10 of MPEG video data consists of packs. On the next layer L11, a pack consists of a pack header, a system header, and packets. On layer L12, a packet consists of a packet header and a GOP. On layer L13, a GOP consists of a GOP header and pictures. On layer L14, a picture consists of a picture header and slices. On layer L15, a slice consists of a slice header and macroblocks (MB).

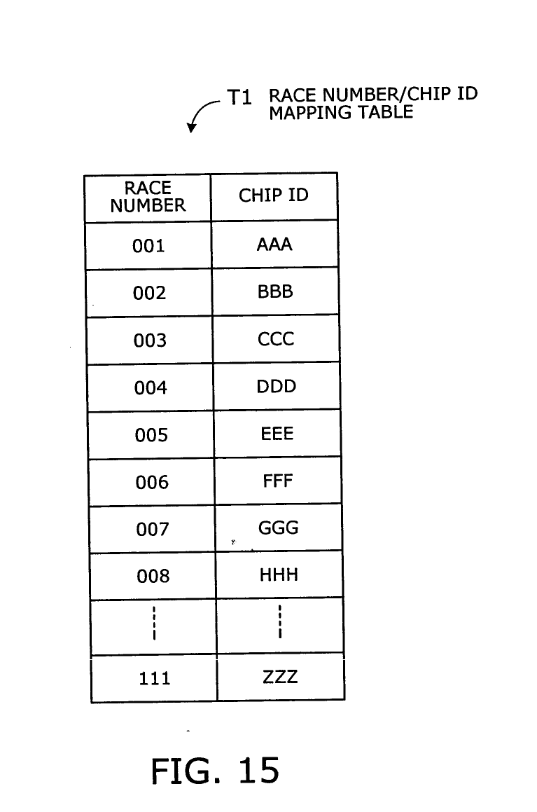

The video authoring unit 4 uses many tables and index files when it retrieves personal video scenes. We will now discuss this with reference to FIGS. 15 to 21.

FIG. 15 shows a race number/chip ID mapping table T1, which associates each runner's race number with the identifier of a tracer chip. Every runner is supposed to have a tracer chip, and this table T1 indicates, for example, that the runner having race number “001” wears a tracer chip with a chip ID of “AAA.”

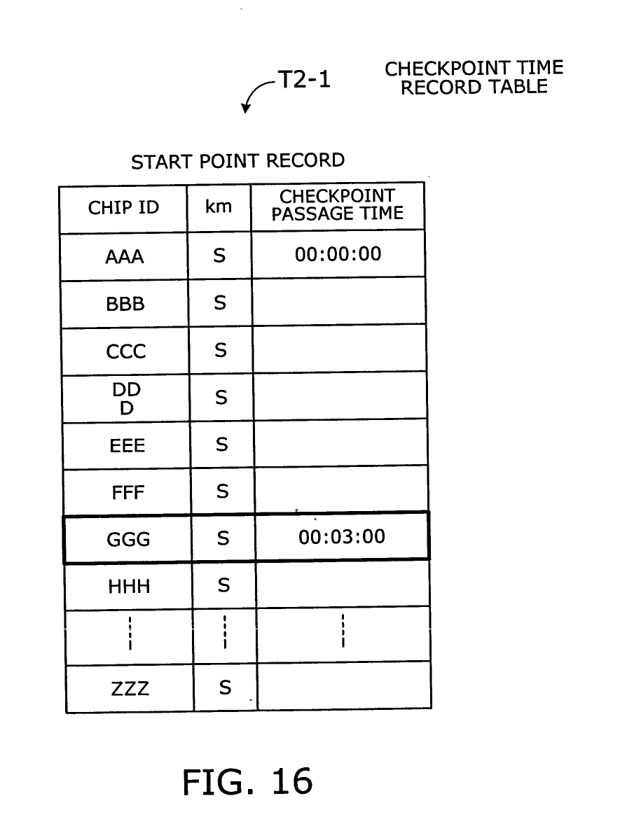

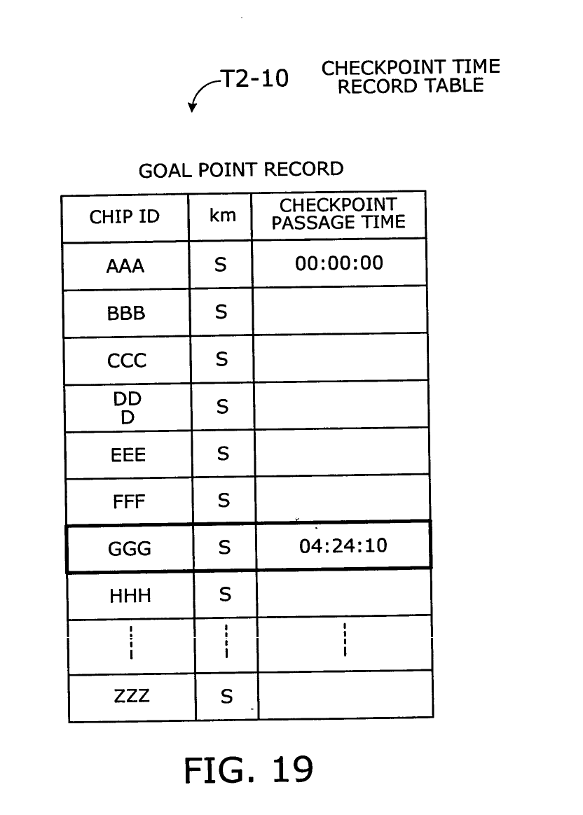

FIGS. 16 to 19 show checkpoint time record tables T2-1, T2-2, T2-3, and T2-10, respectively. Those checkpoint time record tables show who passed which checkpoint and when. Therefore, each table has the following fields: chip ID, checkpoint (represented by distance from start point), and checkpoint passage time. Checkpoint time record table T2-1 of FIG. 16 shows when each runner left the start point. For example, the runner with a chip ID of “GGG” (hereafter, runner “GGG”) started at 00:03:00. Likewise, checkpoint time record table T2-10 of FIG. 19 shows when each runner reached the goal point. For example, the runner “GGG” finished at 04:24:10.

The video authoring unit 4 converts checkpoint passage times to time stamp numbers for use in index files (described later). This conversion is performed as follows. First, the video authoring unit 4 calculates absolute checkpoint passage time in the time-of-day format by adding the measured checkpoint passage time to the start time of the race (recall that checkpoint passage times are measured relative to the start time of the race). It then adds a given record start time (which is a signed time offset with respect to the checkpoint passage time) to the absolute checkpoint passage time and assigns an integer to the result, using an appropriate value mapping algorithm. This integer value, or the time stamp number, is used as an argument in consulting the index file.

Suppose, for example, that the race started at 12:00:00. According to the checkpoint time record table T2-1 of FIG. 16, the runner “GGG” left the start point at 00:03:00 relative to the start time, and therefore his/her absolute checkpoint passage time is determined to be 12:03:00 (=12:00:00+00:03:00). In the case the record start time at the start point was set to minus one minute (i.e., one minute before the start time), the beginning time point of the desired scene is determined to be 12:02:00 by adding −00:01:00 to 12:03:00. The time stamp number in this case is an integer associated with this time value “12:02:00,” which is to be used in scene extraction.

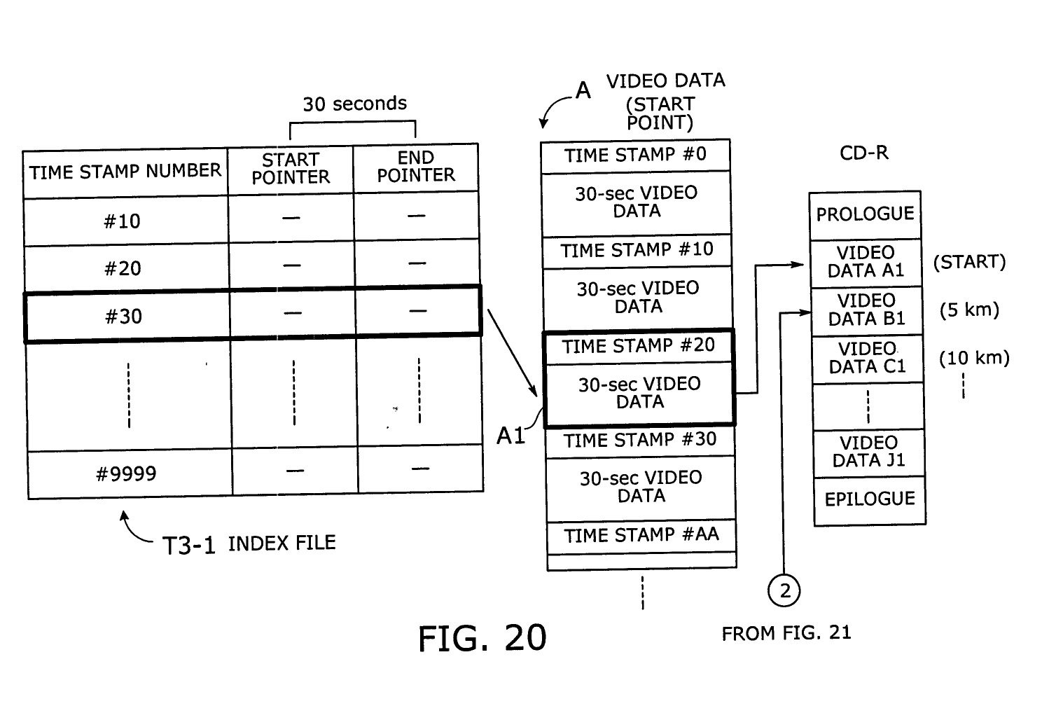

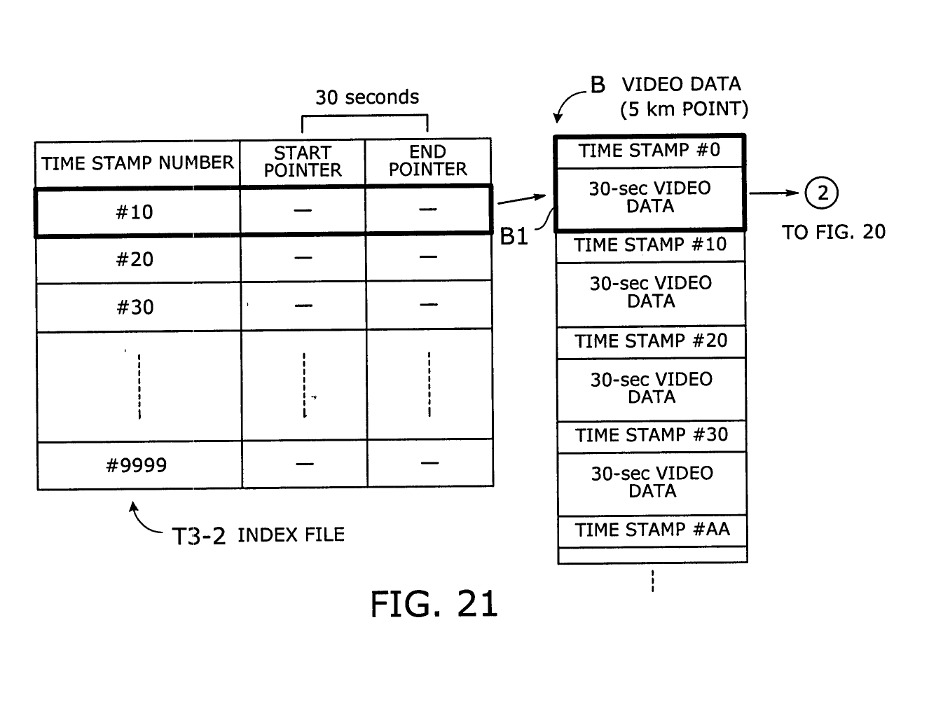

FIGS. 20 and 21 show the relationship between items in an index file and MPEG2 video data. Index files are created for each checkpoint and have three columns to store time stamp numbers, start pointers, and end pointers. Index file T3-1 of FIG. 20 is for the race start point, while index file T3-2 of FIG. 21 is for 5 km checkpoint. The start pointer and end pointer fields of an index file indicate where in the video file the video data segment corresponding to a particular time stamp number is located. In the present example of FIGS. 20 and 21, each segment of video data is 30 seconds in length.

Suppose here that the time stamp number of the runner “GGG” is determined to be #30 through the above-described calculation, based on his/her start point time record. Then the video data segment corresponding to this time stamp number #30 is found at the third segment of video data A (video data at the start point). This segment is shown in FIG. 20 as video data A1 with time stamp “20.” Similarly, when this runner's time stamp number at 5 km point is determined to be #10, the video data segment corresponding to this time stamp number #10 is found at the first segment of video data B (video data at 5 km point), which is shown in FIG. 21 as video data B1 with time stamp “0.” Index files for the other checkpoints are created in the same way and used to find the location of scenes relevant to the runner “GGG” and extract them from the video data. Finally, the extracted scenes and some common scenes are written together in a CD-R or other storage medium, thus producing a personalized video product.

For simplicity, the index file in the above example gives data pointers for every 30-second segment. The actual system, however, measures checkpoint passage times at the resolution of one second, and therefore, the index file should have the same resolution. That is, the increment of time stamp numbers has to be equivalent to the time step size of one second.

As can be seen from the above, the present invention creates index files that show the relationship between time stamps and video data locations in MPEG-2 data files and uses them to retrieve the desired scenes. The system has to scan the entire video data files when creating such index files, but once this is done, the index files permit the system to find desired video scenes of a particular athlete quickly and efficiently, without the need for searching the video data itself. Our evaluation has revealed that the time required for video scene retrieval can be reduced to about one tenth of that without index files.

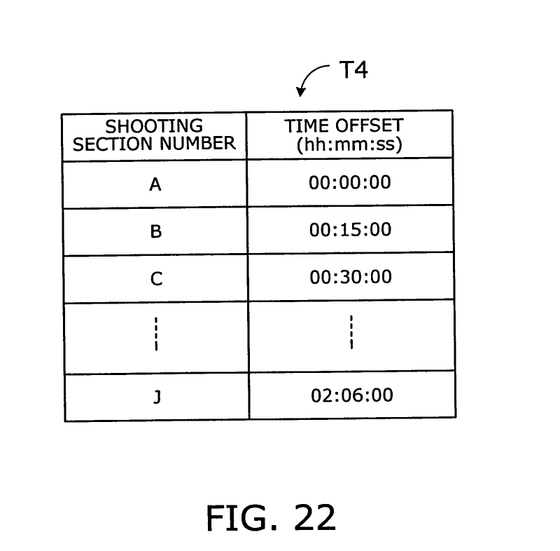

Referring next to FIGS. 22 to 28, we will now describe video configuration files. A video configuration file stores parameters that determine how the video data should be edited, specifying at least one of the following: video shooting section, checkpoint, and video record start time and length. By setting appropriate values to those parameters, we can adapt the video processing system to various arrangement patterns of video recording units and time measurement units.

Video configuration files contain two kinds of information. One is time offsets corresponding to shooting section numbers, and the other is video condition data that defines how a particular part of video data is to be extracted or edited. FIG. 22 shows the former information in the form of a mapping table T4 that associates shooting section numbers and their corresponding time offsets. The time offset field indicates the shooting start time of each shooting section specified by the corresponding shooting section number. For shooting section B, for example, the fixed camera starts to operate fifteen minutes after the race begins, hence the time offset “00:15:00.”

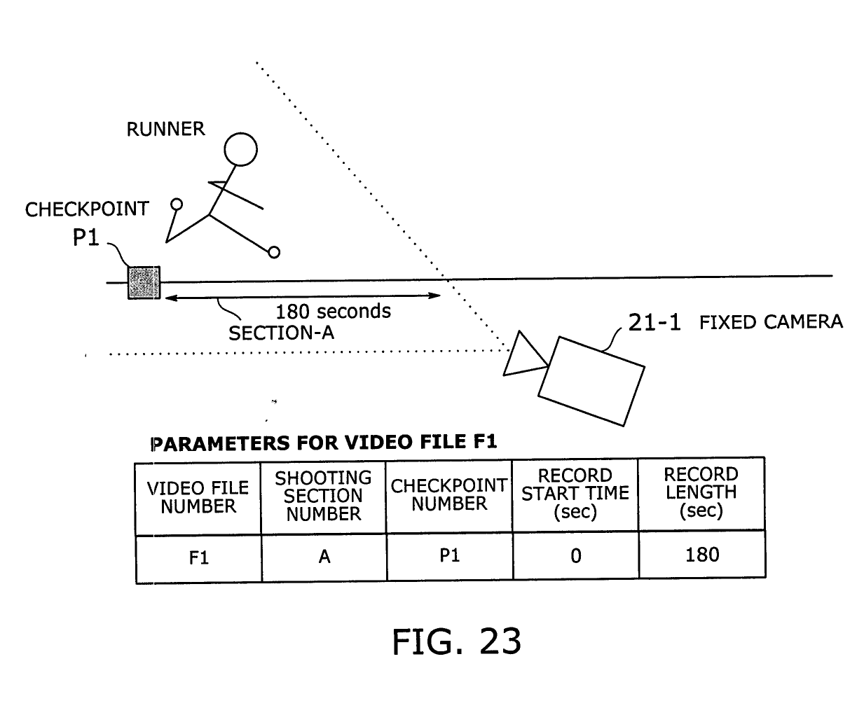

Video condition data, on the other hand, has the following items: video file number, shooting section number, checkpoint number, record start time, and record length. FIGS. 23 to 26 shows several examples of camera setup and its corresponding video condition data.

Referring to FIG. 23, the video condition data is set as follows: video file number=F1, shooting section number=A, checkpoint number=P1, record start time=0 seconds, and record length=180 seconds. This describes the setup of shooting section A, in which a fixed camera 21-1 is aimed at runners leaving checkpoint P1 (start point). Video data for a runner is to be extracted out of the video data file F1 for the duration of 180 seconds, right after his/her passage of checkpoint P1.

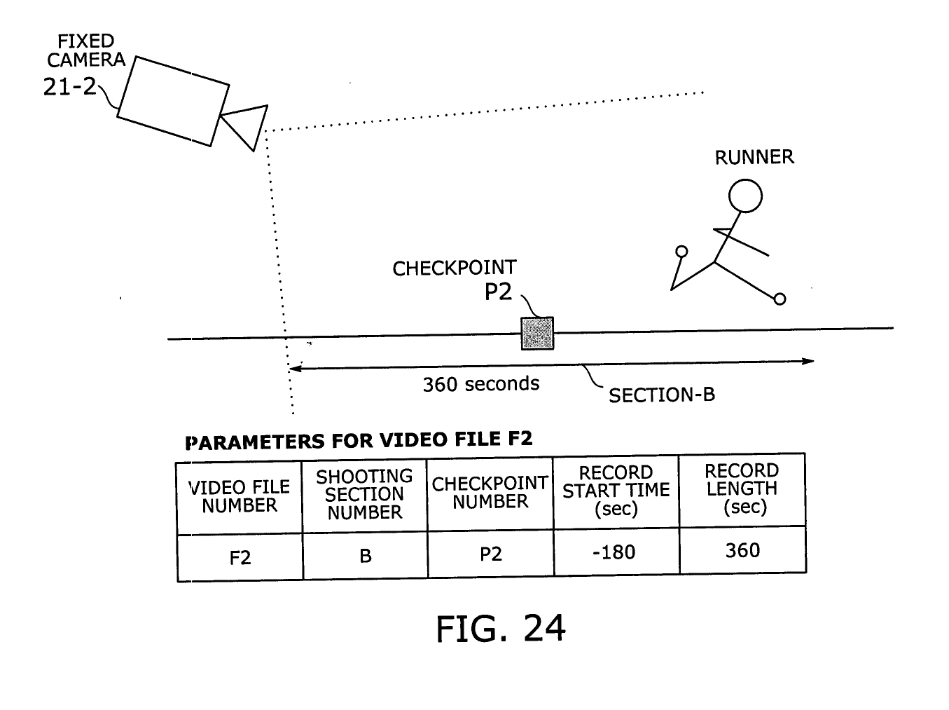

Referring to FIG. 24, the video condition data is set as follows: video file number=F2, shooting section number=B, checkpoint number=P2, record start time=−180 seconds, and record length=360 seconds. This describes the setup of shooting section B, in which a fixed camera 21-2 is aimed at runners passing checkpoint P2. Video data for a runner is to be extracted out of the video data file F2 for the duration of 360 seconds, from 180 seconds before his/her reaches the checkpoint P2.

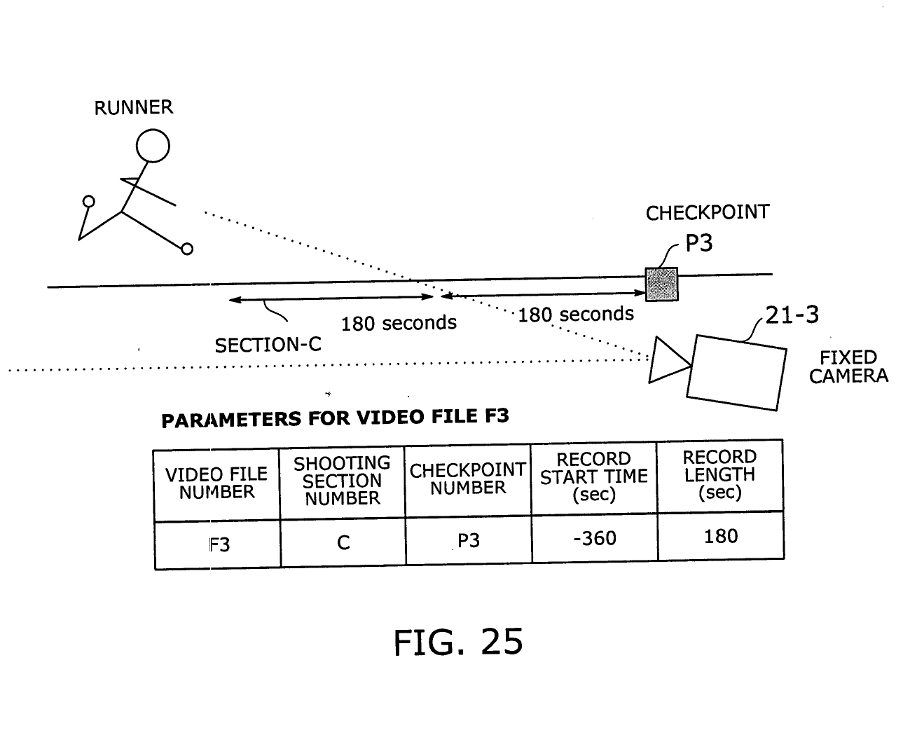

Referring to FIG. 25, the video condition data is set as follows: video file number=F3, shooting section number=C, checkpoint number=P3, record start time=−360 seconds, and record length=180 seconds. This describes the setup of shooting section C, in which a fixed camera 21-3 is aimed at runners coming to checkpoint P3. Video data for a runner is to be extracted out of the video data file F3 for the duration of 180 seconds, from the time point 360 seconds before his/her passage of checkpoint P3.

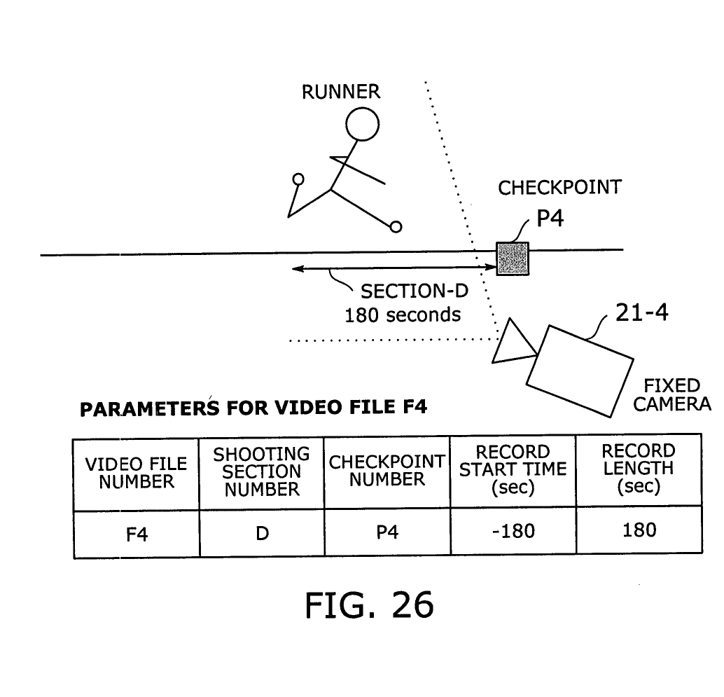

Referring to FIG. 26, the video condition data is set as follows: video file number=F4, shooting section number=D, checkpoint number=P4, record start time=−180 seconds, and record length=180 seconds. This describes the setup of shooting section D, in which a fixed camera 21-4 is aimed at runners nearing checkpoint P4. Video data for a runner is to be extracted out of the video data file F4 for the duration of 180 seconds, from the time point 180 seconds before his/her passage of checkpoint P4.

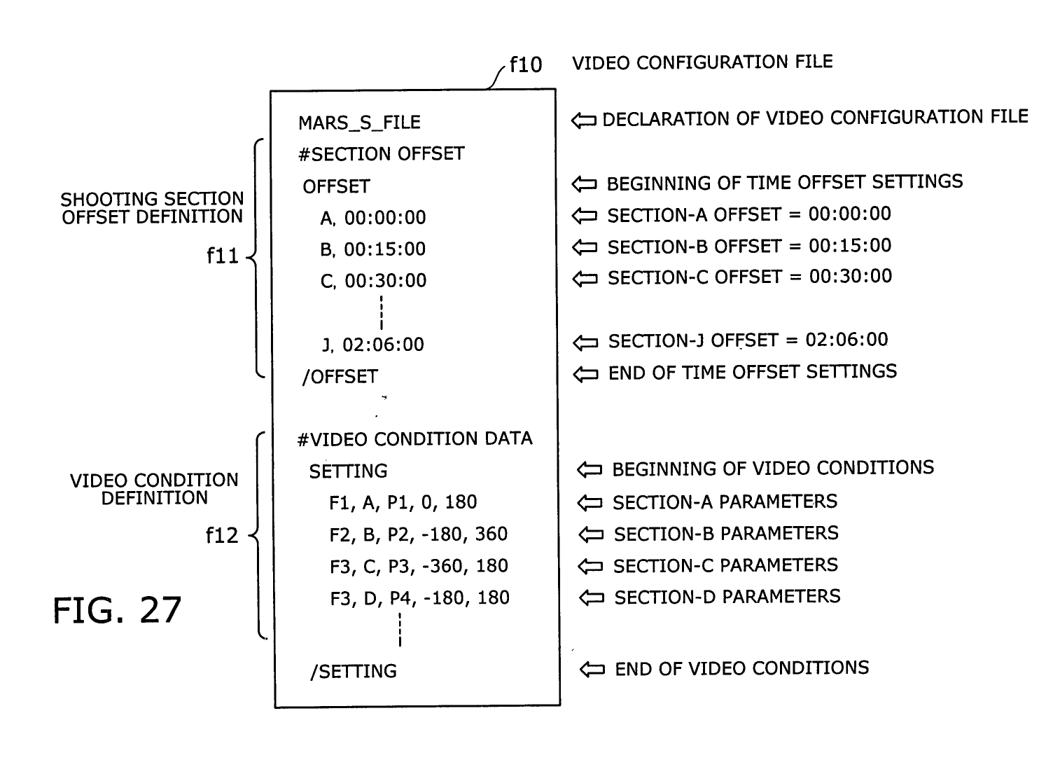

FIG. 27 shows an example of video configuration file format. This video configuration file f10 contains what we have explained in FIGS. 22 to 26. It is a text file written in accordance with the following formatting rules (1) through (12):

(1) Lines beginning with a pound sign (#) are regarded as comments and ignored by the system.

(2) Video configuration files must begin with a string “MARS_S_FILE” as a configuration file identifier. Without this identifier, the entire file would be invalidated. String “MARS_S_FILE” appearing in the middle or end of a file does not serve the purpose.

(3) Shooting section offset definition f11 begins with “OFFSET” and ends with “/OFFSET.” No irrelevant character strings, except comment lines each beginning with #, are allowed between “OFFSET” and “/OFFSET.”

(4) In shooting section offset definition f11, the time offset field must be in the form of “hh:mm:ss” (hours, minutes, and seconds delimited by colons). Other formats are unacceptable.

(5) Shooting section offset definition f11 uses one line for one section. Each section definition should not be spread over two or more lines.

(6) Video condition description f12 begins with “SETTING” and ends with “/SETTING.” No irrelevant character strings, except comment lines each beginning with #, are allowed between “SETTING” and “/SETTING.”

(7) Each entry of video condition description fl2 contains: video file number, shooting section number, checkpoint number, record start time, and record length. These parameters are delimited by commas.

(8) If no sign is present in the field of record start time, the parameter is regarded as positive (i.e., a plus sign is assumed).

(9) In video condition description fl2, record start times and record lengths are specified in units of seconds.

(10) Video condition description fl2 uses one line for one video file. Each definition should not be spread over two or more lines.

(11) Every shooting section number in video condition description fl2 must also be present in the preceding shooting section offset definition f11. The absence would invalidate the entry.

(12) All checkpoint numbers in video condition description f12 must exist. Non-existing checkpoints would invalidate the entry.

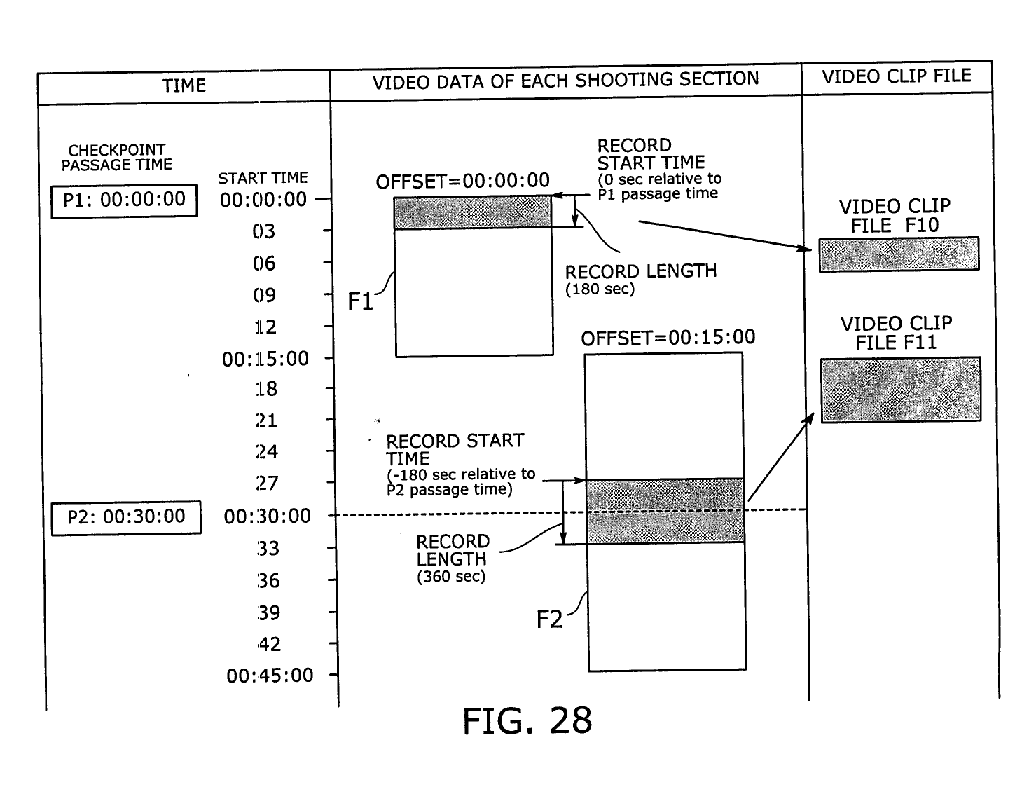

FIG. 28 shows an example of a personalized video authoring process using the video configuration file f10 of FIG. 27. This process extracts intended scenes from the video data that has been captured at each point and arranges them in the time sequence, according to the given video configuration file f10.

Specifically, the authoring process begins with the first video data file F1 with time offset 00:00:00, which was captured at the start point P1 for the period of 00:00:00 (race start time) to 00:15:00. It extracts a part of this video data #A1 for the duration of 180 seconds from the very beginning (i.e., zero seconds relative to the checkpoint passage time measured at the start point P1. The extracted video clip file is numbered as F10.

The authoring process then selects the second video data file F2 with time offset 00:15:00, which was captured at checkpoint P2 for the period of 00:15:00 to 00:45:00. Suppose that the runner of interest passed checkpoint P2 at 00:30:00. Because the video configuration file f10 specifies the record start time of −180 seconds and the record length of 360 seconds for this video data file F2, the authoring process extracts a video clip that starts 180 seconds before the checkpoint passage time 00:30:00, as shown in the lower half of FIG. 28. The extracted video clip file is numbered as F11.

As can be seen from the above example, the proposed system creates a video configuration file that provides a list of shooting sections, checkpoints, video record start times, and video record lengths. The use of such a video configuration file in compiling video files enables the system to cope with various arrangements of video recording units 2 and time measurement units 3.

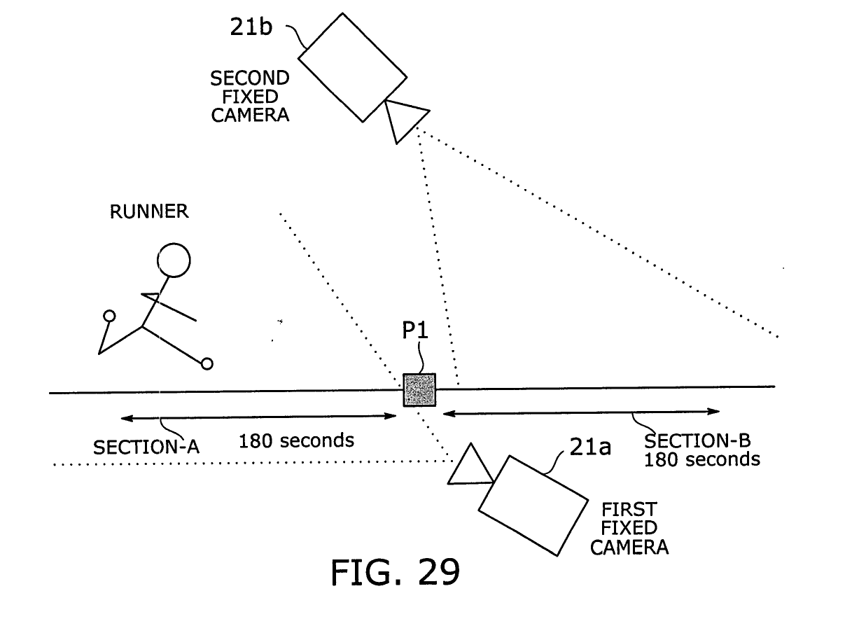

In the discussion of FIGS. 23 to 26, we have assumed one-to-one association between shooting sections and checkpoints. In other words, the checkpoints have only one fixed camera to shoot videos. This configuration only allows us to extract a single set of motion pictures corresponding to each checkpoint time record, thus imposing limitations on our choice for camera angles. The present invention addresses the above problem by allocating two or more fixed cameras to a single checkpoint and scripting an appropriate video configuration file for extracting a plurality of video clip files from video data captured at that checkpoint. Referring now to FIGS. 29 to 31, the following section will describe how the proposed system supports multiple camera configurations.

For one example, FIG. 29 shows a setup which uses two fixed cameras 21a and 21b to respectively cover two sections A and B before and after checkpoint P1. More specifically, the first fixed camera 21a is aimed at runners coming near to checkpoint P1. Video data of each runner is to be extracted for the duration of 180 seconds until he/she reaches P1. The video configuration file thus contains a line for the first fixed camera 21a which specifies record start time=−180 and record length=180. The second fixed camera 21b, on the other hand, takes a rear view of runners leaving checkpoint P1. Video data of each runner is to be extracted for the duration of 180 seconds after he/she has reached the checkpoint P1. Thus the video configuration file contains a line for the second fixed camera 21b which specifies record start time=0 and record length=180.

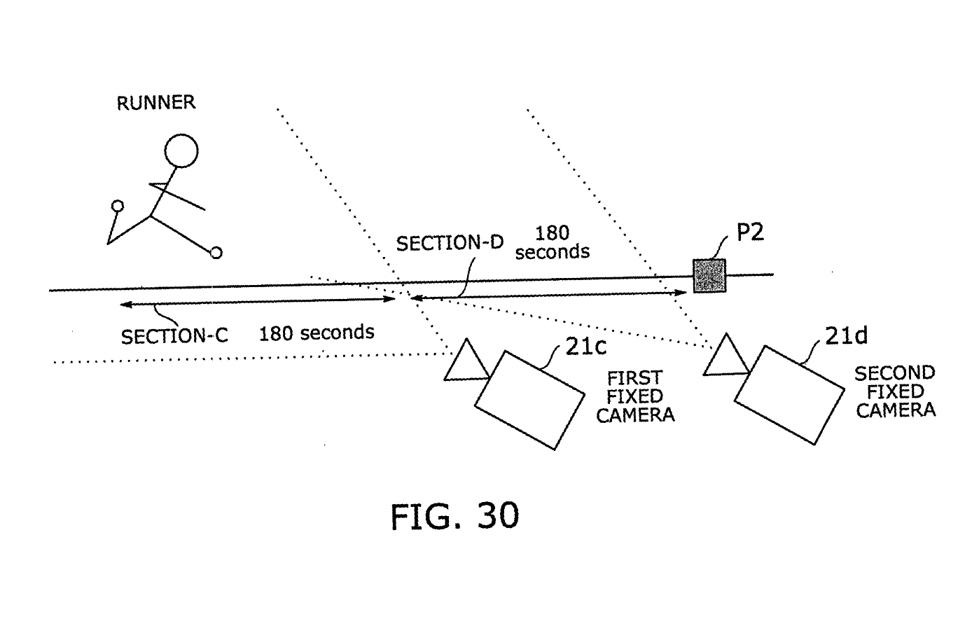

FIG. 30 gives another example of two-camera configuration, in which two fixed cameras 22c and 22d catch the front view of runners in two consecutive sections C and D before checkpoint P2. More specifically, the first fixed camera 21c catches runners earlier than the second fixed camera 21d. Video data of each runner is extracted for the duration of 180 seconds until he/she enters the next camera coverage section D. The video configuration file thus contains a line for the first fixed camera 21c which specifies record start time=−360 and record length=180. The second fixed camera 21d immediately follows the first fixed camera 21c for another 180 seconds until the runners reach the checkpoint P2. Video data of each runner is extracted for this duration of 180 seconds, and therefore, the video configuration file contains a line for the second fixed camera 21d which specifies record start time=−180 and record length=180.

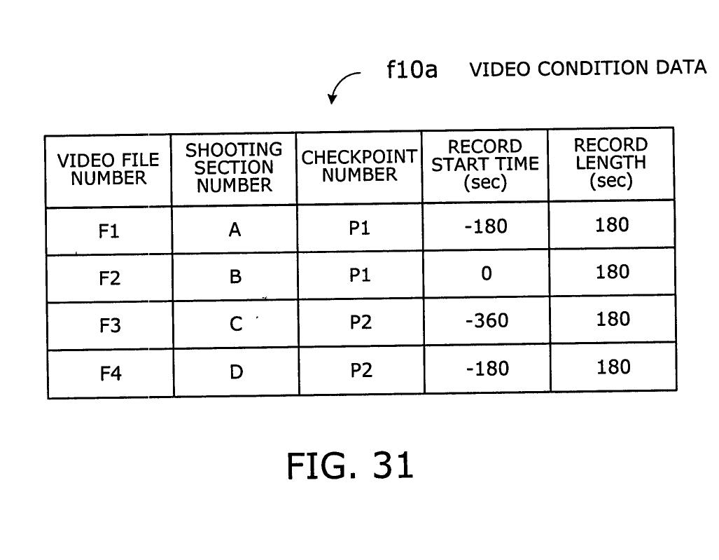

FIG. 31 shows video condition data f10a (a part of the video configuration file) for the two-camera configurations explained in FIGS. 29 and 30. As can be seen from FIGS. 29 and 30, the use of two or more cameras for a single checkpoint enables us to take larger pictures of passing runners for a longer time. The video configuration file enables us to make this type of setup by associating one checkpoint with a plurality of video data files, as shown in the video condition data f10a of FIG. 31.

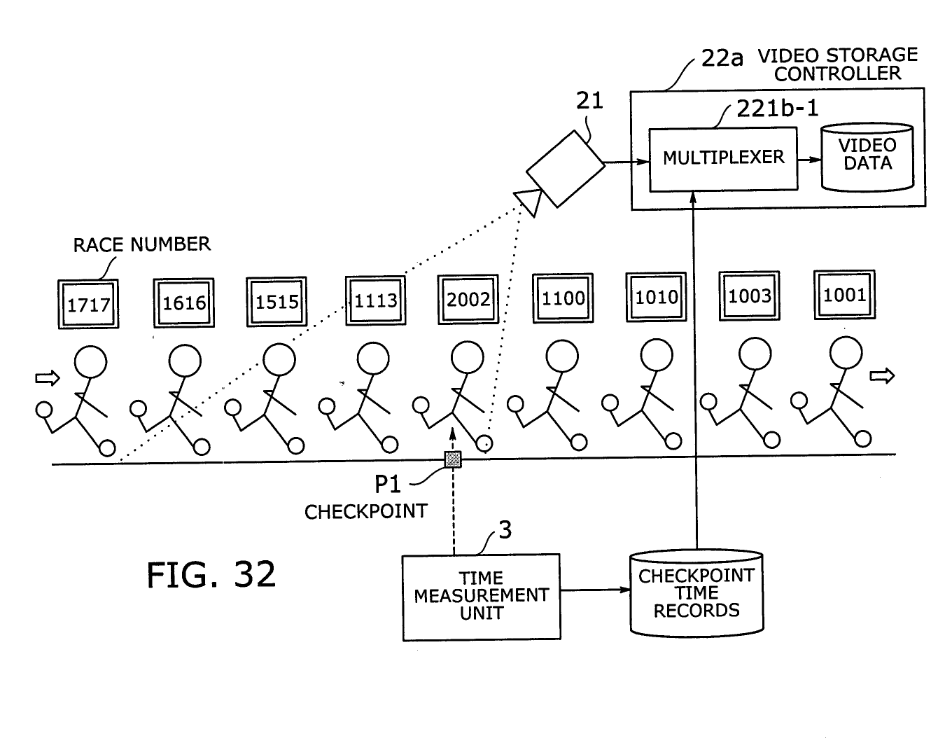

Referring next to FIGS. 32 to 34, the following is a variation of the proposed video processing system in which the identifiers of runners are inserted to video data according to their respective checkpoint passage times. FIG. 32 shows a situation where the camera shoots runners and the system records their checkpoint passage times. This structure is basically the same as what we have explained earlier in FIG. 11, except that the video storage controller 22a has a multiplexer 221b-1 to put checkpoint time records into video data. Actually the multiplexer 221b-1 is implemented as a software task of the CPU 221b.

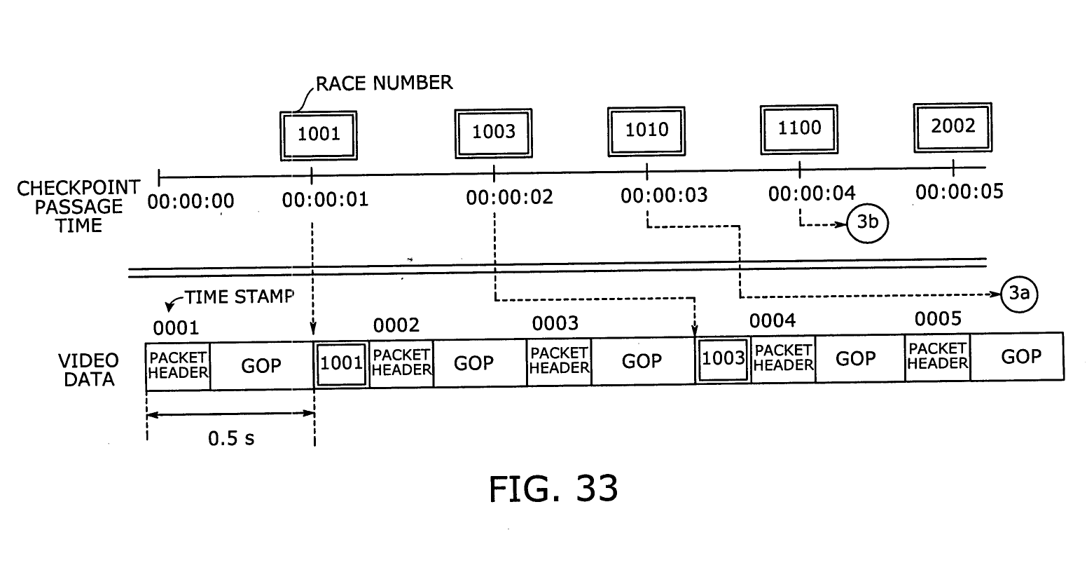

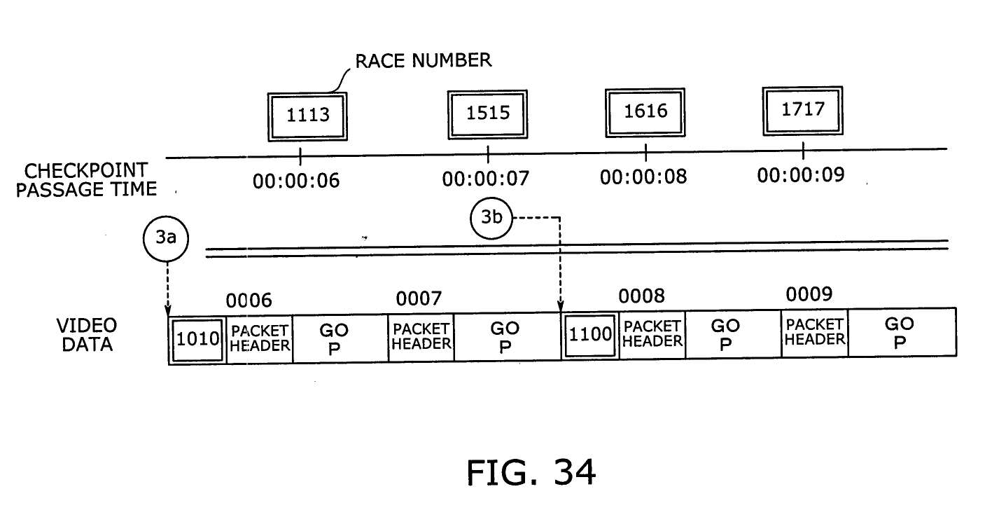

FIGS. 33 and 34 show how race numbers are inserted in a video data stream as the identifiers of runners. For example, the runner with race number “1001” has passed the checkpoint P1 at 00:00:01. In this case, his/her race number “1001” is inserted before the packet with time stamp “0002” which corresponds to that checkpoint passage time 00:00:01. Likewise, race number “1003” is inserted before its corresponding packet with time stamp “0004.”

While race numbers are used in the above example, other pieces of information such as chip IDs or runner names can also work as identifiers. Such athlete identifiers embedded in the video data enables desired scenes to be retrieved at high speeds. Note that there is no need to calculate the location of desired scenes from runner's time records because it is directly indicated by the identifiers embedded in the video data.

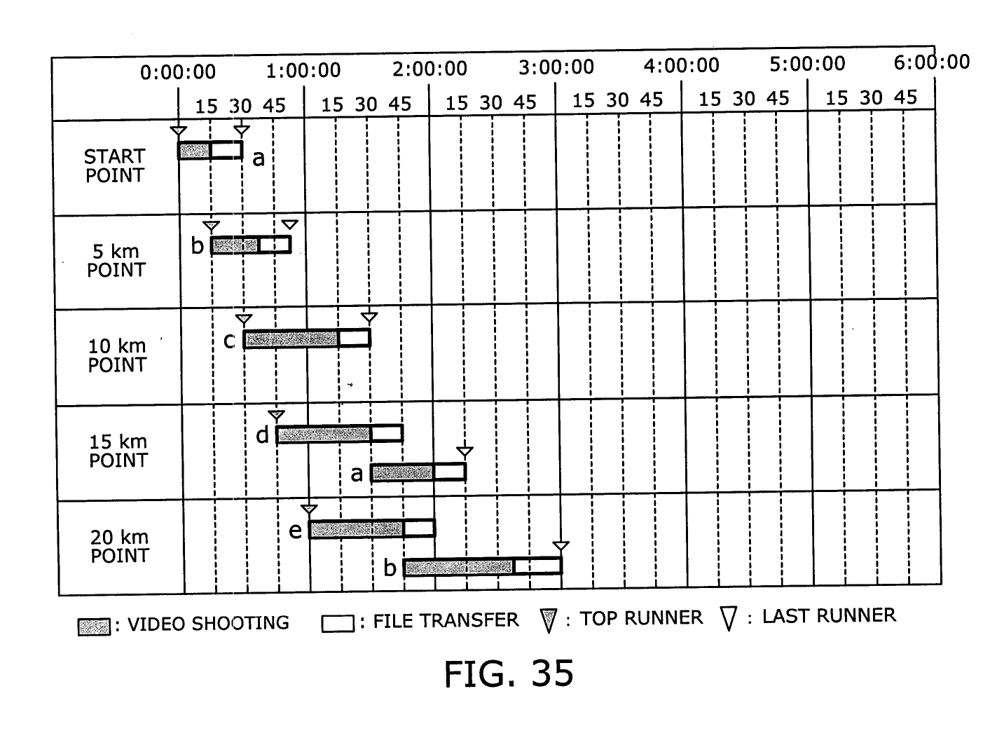

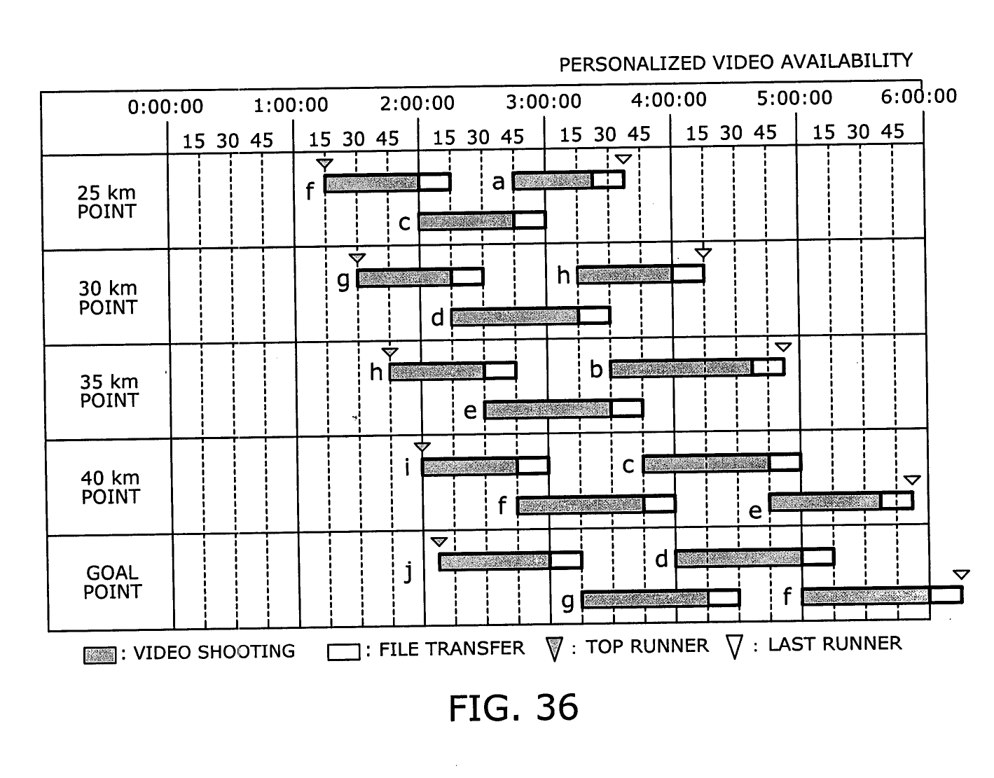

Referring lastly to FIGS. 35 and 36, we will describe a technique to expedite the delivery of personalized video files by bringing video recording units 2 to subsequent video shooting sites according to the progress of the race. In our earlier explanation of the system shown in FIGS. 4 and 5, we have assumed that video recording units 2 are fixed at each point and never be moved until the race ends. This means that the top runner has to wait four hours before he/she can receive his/her video disk or tape. Therefore, if it is possible to expedite the delivery of videos, that will be beneficial to such top-group runners. The idea is that when the video recording unit at a certain checkpoint has finished its duty, it is brought to one of the subsequent checkpoints in order to reuse the unit at the new location, and in addition, the aforementioned embedded athlete identifiers are used to make a high-speed scene search possible.

FIGS. 35 and 36 show how the above idea can be implemented in the system arrangement shown in FIGS. 2 and 3. The video shooting period at each checkpoint are shown in these diagrams, where the system deploys ten video recording units 2-1 to 2-10 (labeled “a” to “j” in FIGS. 35 and 36) along the race course.

At the start point, it takes fifteen minutes for the first video recording unit 2-1 (“a”) to capture the video of all runners. The first video recording unit 2-1 (“a”) then spends another fifteen minutes to transfer its video data to the video authoring unit 4 located in a remote site. When this file transfer task is finished, the first video recording unit 2-1 (“a”) is moved forward to the 15 km point for replacement. When this recording unit 2-1 (“a”) becomes ready (at 01:30:00 in the present example), the fourth video recording unit 2-4 (“d”) at the 15 km point is stopped. At this point in time, its storage device contains video data for the period of 00:45:00 to 01:30:00. The fourth video recording unit 2-4 then transfers its video data to the video authoring unit 4. (which takes fifteen minutes), while leaving its duties to the first video recording unit 2-1 (“a”) that is now working at the 15 km point. When this file transfer is finished, the fourth video recording unit 2-4 (“d”) is carried forward to 30 km point. Similarly, the first video recording unit 2-1 (“a”) is removed from 15 km point and sent to 25 km point when its task at 15 km point is done. In this way, video recording units are moved from one point to another, according to the progress of the race. Within an hour or so after the top runner has passed over the finishing line, the video authoring unit 4 receives all necessary data for authoring a personalized video product for that runner.

We have described preferred embodiments of the present invention. To summarize, the video processing system of the present invention has fixed cameras and video recording units to store video of moving objects together with time stamps that indicate at what time each part of the video was captured. Time measurement units are deployed at checkpoints on the course to measure checkpoint passage time of every passing moving object and store checkpoint time records including the measured times. A video authoring unit searches the video data stored in the video recording units to find and extract scenes of a particular moving object, using the checkpoint time records in association with time stamps in the video data, and writes them in a video storage medium.

The proposed system structure realizes quick and efficient extraction of video scenes of a moving object, with improved video management capability, operability, and service quality. Also, the present invention enables us to start producing and providing personalized video products as soon as the source video data becomes ready, without the need for marking it up with additional tags for editing video files. The present invention also permits us to reduce the number of working staff required to offer video production services quickly enough to satisfy individual customers' needs. With the aid of the present invention, a few knowledgeable operators can perform this task.

Yet another advantage of the present invention is that the system is scalable and flexible in terms of the number of shooting sections, video record length, and the number of video media products, which may vary from race to race, depending on the amount of budget. Further, the present invention provides instant editing of personal video scenes, with which all the necessary tasks can be finished before the day is over.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A video processing system that shoots video of moving objects at a plurality of points, extracts intended scenes, and compiles the extracted scenes into a video product, the system comprising:
(a) a plurality of video recording units, each of which comprises:
a fixed camera that captures video of each passing moving object, and
a video storage controller that stores video data including the captured video of the moving objects and time stamps that indicate at what time each part of the video was captured;
(b) a plurality of time measurement units deployed at checkpoints, each of which measures checkpoint passage time of each passing moving object and stores checkpoint time records including the measured checkpoint passage times and identifiers of the individual moving objects; and
(c) a video authoring unit that searches the video data stored in said video recording units to find and extract scenes of one of the moving objects, using the checkpoint time records in association with the time stamps in the video data, and compiles the extracted scenes into a video product.

2. The video processing system according to claim 1, wherein said video authoring unit creates index files containing time stamp numbers that derive from the checkpoint time records and uses the index files to find scenes of one of the moving objects that is specified.

3. The video processing system according to claim 1, wherein said video authoring unit produces and uses a video configuration file that contains parameters including at least one of video shooting section, checkpoint, and video record start time and length, whereby said video authoring unit can extract scenes in various ways.

4. The video processing system according to claim 3, wherein:
two or more of said video recording units are placed around one of the checkpoints; and
using the video configuration file, said video authoring unit extracts a plurality of video clip files from the video data that has been captured at said one of the checkpoints.

5. The video processing system according to claim 1, wherein said video recording units insert identifiers into the video data in association with the checkpoint passage times to identify the individual moving objects.

6. A video processor that retrieves motion pictures from video data using shooting time data and checkpoint passage data, the video data having been captured by a fixed point camera that is placed at a predetermined distance from a checkpoint, the shooting time data indicating at what time each part of the video data was captured, the checkpoint passage data associating a time record that indicates at what time a subject passed the checkpoint with an identifier of the subject, the video processor comprising:
a time record retrieval unit that searches the checkpoint passage data to find a time record associated with a given identifier; and
a video record retrieval unit that identifies shooting time data having a predetermined temporal relationship with the time record that is found and searches the video data for a scene that corresponds to the shooting time data identified.

7. A video recording unit which shoots video of moving objects, comprising:
a fixed camera; and
a video storage controller that stores motion pictures of the moving objects captured by said fixed camera, together with time stamps that indicate at what time the motion pictures were captured.

8. The video recording unit according to claim 7, wherein said video storage controller inserts identifiers into the video data in association with the checkpoint passage times, to identify the individual moving objects.

9. A video authoring unit which extracts intended scenes and compiles into a video product, comprising:
a video record retrieval unit that automatically searches stored video data to find and extract scenes of the moving object, using time stamps in association with checkpoint time records that include identifiers and checkpoint passage times of moving objects; and
a video compilation unit that compiles the extracted scenes into a video product.

10. The video authoring unit according to claim 9, wherein said video record retrieval unit creates index files containing time stamp numbers that derive from the checkpoint time records and uses the index files to find scenes of one of the moving objects that is specified.

11. The video authoring unit according to claim 9, wherein said video compilation unit produces and uses a video configuration file that contains parameters including at least one of video shooting section, checkpoint, and video record start time and length, whereby said video compilation unit can extract scenes in various ways.

12. The video authoring unit according to claim 11, wherein said video authoring unit, using the video configuration file, extracts a plurality of video clip files from the video data captured at one checkpoint.

13. A video processing method that shoots video of moving objects at a plurality of checkpoints, extracts intended scenes, and compiles the extracted scenes into a video product, comprising the steps of:
(a) taking video of the moving objects with fixed cameras;
(b) storing video data that includes the video of the moving objects and time stamps indicating at what time each part of the video was taken;
(c) at the plurality of checkpoints, recording passage time of each moving object;
(d) storing checkpoint time records that include the passage times and identifiers of the moving objects;
(e) automatically extracting scenes of one of the moving object, based the checkpoint time records in association with the time stamps in the stored video data; and
(f) compiling the extracted scenes into a video product.

14. The video processing method according to claim 13, wherein said extracting step (e) creates index files containing time stamp numbers that derive from the checkpoint time records and uses the index files to find scenes of one of the moving objects that is specified.

15. The video processing method according to claim 13, wherein said extracting step (e) produces and uses a video configuration file that contains parameters including at least one of video shooting section, checkpoint, and video record start time and length, whereby said extracting step (e) can extract scenes in various ways.

16. The video processing method according to claim 15, wherein:
two or more fixed cameras are placed around one of the checkpoints; and
using the video configuration file, said extracting step (e) extracts a plurality of video clip files from the video that has been taken at said one of the checkpoints.

17. The video processing method according to claim 13, further comprising the step of inserting identifiers into the video data in association with the checkpoint passage times to identify the individual moving objects.

18. A sports video processing method that shoots video of a sports game or race in which participating athletes change locations with time along a given course and compiles video scenes of a particular athlete into a personalized video product, the method comprising the steps of:
(a) taking video of all the athletes along the course, using video recording units each having a fixed camera which are placed at a plurality of places on the course;
(b) storing video data that includes the video of the athletes and time stamps indicating at what time each part of the video was taken;
(c) recording passage time of every athlete who passes each of a plurality of checkpoints on the course and storing checkpoint time records that include the passage times and identifiers of the athletes;
(d) out of the stored video data including the time stamps, automatically extracting scenes of each particular athlete passing the checkpoints, based on the checkpoint time records; and
(e) producing a personalized video product by writing the extracted scenes into a video storage medium.

19. The sports video processing method according to claim 18, wherein said extracting step (d) creates index files containing time stamp numbers that derive from the checkpoint time records and uses the index files to find the scenes of each particular athlete that is specified.

20. The sports video processing method according to claim 18, wherein said extracting step (d) produces and uses a video configuration file that contains parameters including at least one of video shooting section, checkpoint, and video record start time and length, whereby said extracting step (d) can extract scenes in various ways.

21. The sports video processing method according to claim 20, wherein:
two or more video recording units are placed around one of the checkpoints; and
using the video configuration file, said extracting step (d) extracts a plurality of video clip files from the video data that has been taken at said one of the checkpoints.

22. The sports video processing method according to claim 18, wherein further comprising the step of inserting identifiers into the video data in association with the checkpoint passage times to identify the individual athletes.
